(19) United States
(12) Patent Application Publication
(10) Pub. No.: US 2016/0214069 A1
(43) Pub. Date: Jul. 28, 2016

(54) NOVEL NANO-PATTERNED THIN FILM MEMBRANES AND THIN FILM COMPOSITE MEMBRANES, AND METHODS USING SAME

(71) Applicant: THE REGENTS OF THE UNIVERSITY OF COLORADO, A BODY CORPORATE, Denver, CO (US)

(72) Inventors: YIFU DING, SUPERIOR, CO (US); SAJJAD H. MARUF, BOULDER, CO (US); JOHN PELLEGRINO, BOULDER, CO (US); ALAN R. GREENBERG, BOULDER, CO (US)

(21) Appl. No.: 15/025,041

(22) PCT Filed: Sep. 26, 2014
(86) PCT No.: PCT/US14/57718

§ 371 Date: Mar. 25, 2016

Related U.S. Application Data
(60) Provisional application No. 61/882,928, filed on Sep. 26, 2013.

(51) Int. Cl. B01D 71/68; B01D 71/56; B01D 71/48; B01D 71/50; B01D 71/64; B01D 61/02; B01D 71/52; B01D 69/12; B01D 71/24; B01D 69/02; B01D 61/14; B01D 71/16; B01D 71/54

(52) U.S. Cl. CPC B01D 71/68; B01D 71/16; B01D 71/56; B01D 71/48; B01D 71/50; B01D 71/64; B01D 71/54; B01D 71/52; B01D 69/125; B01D 71/24; B01D 69/02; B01D 61/145; B01D 61/025

(57) ABSTRACT

The present invention includes a patterned thin film membrane and a patterned thin film composite membrane. The present invention also includes a method of making and using the patterned membranes of the invention.

### CROSS-REFERENCE TO RELATED APPLICATIONS

The present application claims priority under 35 U.S.C. §119(e) to U.S. Provisional Patent Application No. 61/882,928, filed Sep. 26, 2013, which application is incorporated herein by reference in its entirety.

### BACKGROUND OF THE INVENTION

Polymeric membranes are used in pressure driven separation, among other applications. These membranes often allow for controlled permeation of chemical species, depending on the material used. However, continuous operation of polymeric membranes is hindered by fouling phenomena such as deposition and concentration polarization of materials (such as retained particles, bacteria, algae, colloids, macromolecules and salts) at the membrane surface, inside the pores or on the pore walls. This fouling causes a reduction in the permeation/flux from the initial rate (Potts, et al., 1981, Desalination 36:235; Rana, 2010, Chemical Reviews 110:2448-2471). These challenging feed streams reduce membrane productivity and lifetime, resulting in higher operating and replacement costs.

Hence, efforts have been directed to identifying approaches for eliminating or minimizing fouling of polymeric membranes. Such efforts include chemical treatments, adsorption of surfactants, low-temperature plasma treatments, irradiation methods and addition of hydrophilic particles on the membrane surface (Belfer, et al., 1998, J. Membr. Sci. 139:175-181; Mukherjee, et al., 1996, Desalination 104:239-249; Rana et al., 2010, Chem. Rev. 110:2448-2471; Yang et al., 2009, Water Res. 43:3777-3786), but have been met with minimal success at best.

There is a need in the art to identify novel thin film membranes and thin film composite (TFC) membranes that display chemical selectivity and good permeability, as well as good mechanical strength and fouling resistance. The present invention meets this need.

### BRIEF SUMMARY OF THE INVENTION

The invention provides a thin film membrane. The invention further provides a thin film composite membrane. The invention further provides a method of preparing a thin film composite membrane. The invention further provides a method of filtering a component from a fluid.

In certain embodiments, the thin film membrane comprises a first surface and a second surface counterfacing the first surface. In other embodiments, a repeating pattern covers a portion of a working area of the thin film membrane. In yet other embodiments, the periodicity of the repeating pattern is equal to or lower than about 1 micrometer in size. In yet other embodiments, the repeating pattern covers a portion of at least one selected from the group consisting of the first surface and the second surface of the thin film membrane.

In certain embodiments, the composite membrane comprises a base membrane. In other embodiments, the composite membrane further comprises a thin film membrane on a given surface of the base membrane. In yet other embodiments, the composite membrane further comprises a repeating pattern covering both the thin film membrane and the given surface of the base membrane. In yet other embodiments, the periodicity of the repeating pattern is equal to or lower than about 1 micrometer in size.

In certain embodiments, the repeating pattern covers between about 20% and about 100% of the working area of the thin film membrane and/or thin film composite membrane.

In certain embodiments, the thin film membrane comprises at least one material selected from the group consisting of cellulose acetate, polysulfone, polyethersulfone, ionic liquid, self-assembled monolayer, rubbery polymer, polyamide, polyaramid, polyester, polycarbonate, polycarbamate, polyimine, polyurea, polyalcohol, polyether, polyphosphine, and any derivatives thereof.

In certain embodiments, the thin film membrane further comprises at least one material selected from the group consisting of dispersed nanoparticle, metal organic framework, graphene flake, graphene oxide flake, metal oxide, carbon particle, silver, and zeolitic imidazolate framework. In other embodiments, the thin film membrane comprises a polyamide.

In certain embodiments, the base membrane comprises at least one material selected from the group consisting of nylon, mixed cellulose esters, regenerated cellulose, cellulose acetate, polycarbonate, polytetrafluoroethylenes, polypropylene, polystyrene, polyvinylchloride, polysulfone, poly (ether sulfone), and polyethylene.

In certain embodiments, the base membrane comprises a polyethersulfone ultrafiltration membrane and the thin film membrane comprises a polyamide.

In certain embodiments, the pattern comprises raised or depressed portions that form shapes that include one or more of ridges, valleys, channels, hills, posts, peaks, needles, pins, knobs, parallel lines, intersecting lines and concentric lines on the thin film membrane and/or thin film composite membrane.

In certain embodiments, the pattern comprises raised portions (projections) arranged on the thin film membrane and/or thin film composite membrane with a periodicity of the projections being between 10 and 1,000 nm when measured at their widest point. In other embodiments, the pattern comprises a periodicity in a range from about 200 nm to 1,000 nm; groove depth in a range from 5 nm to 300 nm; and a line-to-space ratio in a range from about 1:1 to 1:5.

In certain embodiments, the thin film membrane is formed or prepared using interfacial polymerization.

In certain embodiments, the method comprises passing the fluid comprising the component through a thin film composite membrane. In other embodiments, the ratio of the component in the composition that exits the composite membrane is lower than the ratio of the component in the fluid.

In certain embodiments, the fluid is a liquid. In other embodiments, the component is at least one selected from a group consisting of a macromolecular with molecular weight in the range of 10³-10⁶ Da; a monovalent or polyvalent cation; and a microorganism. In yet other embodiments, the component comprises Na⁺ or Ca²⁺. In yet other embodiments, the solution is stirred during the filtration process.

### BRIEF DESCRIPTION OF THE DRAWINGS

For the purpose of illustrating the invention, there are depicted in the drawings certain embodiments of the invention. However, the invention is not limited to the precise arrangements and instrumentalities of the embodiments depicted in the drawings.

FIG. 1 comprises FIGS. 1A-1C. FIG. 1A is a scheme illustrating nanoimprint lithography to make patterned ultrafiltration (UF) membrane. FIG. 1B is a scheme illustrating the generation of a TFC membrane using interfacial polymerization. FIG. 1C is a set of scanning electron microscope (SEM) images illustrating the topographic properties of UF membrane, patterned UF membrane, and patterned TFC membrane.

FIG. 2 is a graph illustrating the attenuated total reflectance Fourier transform infrared spectroscopy (FTIR-ATR) spectra of a patterned TFC membrane (thin solid line), a patterned (polyethersulfone) PES UF support membrane (thick solid line), a patterned TFC membrane after 2 hours of deionized (DI) water filtration (dash-dot line).

FIG. 3 comprises FIGS. 3A-3F. FIGS. 3A-3D is a set of SEM images illustrating the topology of PES UF support membrane, flat TFC membrane, patterned TFC membrane, and cross section of the patterned TFC membrane respectively. FIG. 3E is a graph illustrating the expected layer morphology and thickness of the flat TFC membrane generated using random multiple scans across the membrane surface. FIG. 3F is a graph illustrating the expected layer morphology and thickness of the patterned TFC membrane generated using random multiple scans across the membrane surface.

FIG. 4 is a graph illustrating pure water flux (at constant applied transmembrane pressure of 2.75 MPa with prior compaction) as a function of transmembrane pressure difference (TMP) for flat and patterned TFC membranes.

FIG. 5 is a bar graph illustrating the differences of permeate flux (water) between flat and patterned TFC membranes with selected commercial nanofiltration (NF) and reverse osmosis (RO) membranes.

FIG. 6, comprising FIGS. 6A-6B, illustrates dead-end filtration performance of flat and patterned polyamide TFC membranes with NaCl salt. FIG. 6A is a graph illustrating permeate flux as a function of filtration time for flat (filled symbols) and patterned (open symbols) TFC membranes in unstirred (square) and stirred (circle) conditions. FIG. 6B is a graph illustrating rejection as a function of filtration time for flat (filled symbols) and patterned (open symbols) TFC membranes in unstirred (square) and stirred (circle) conditions. Test conditions: feed=1 g/L NaCl aqueous solution; transmembrane pressure difference=400 psi (2.76 MPa); feed pH=7.1; feed temperature=25±0.5° C.

FIG. 7, comprising FIGS. 7A-7B, illustrating dead-end filtration performance of flat and patterned polyamide TFC membranes with CaCl₂ salt. FIG. 7A is a graph illustrating permeate flux as a function of filtration time for flat (filled symbols) and patterned (open symbols) TFC membranes in unstirred (square) and stirred (circle) conditions. FIG. 7B is a graph illustrating rejection as a function of filtration time for flat (filled symbols) and patterned (open symbols) TFC membranes in unstirred (square) and stirred (circle) conditions. Test conditions: feed=1 g/L CaCl₂ aqueous solution; transmembrane pressure difference=400 psi (2.76 MPa); feed pH=7.2; feed temperature=25±0.5° C.

FIG. 8 comprises FIGS. 8A-8C. FIG. 8A is graph illustrating permeate flux as a function of filtration time for flat (black square) and patterned (circles) TFC membranes for CaSO₄ (gypsum) salt filtration in a stirring condition. FIG. 8B is a SEM image illustrating flat polyamide TFC membrane surfaces after gypsum filtration. FIG. 8C is a SEM image illustrating patterned polyamide TFC membrane surfaces after gypsum filtration.

FIG. 9 is a schematic drawing illustrating a filtration set up.

FIG. 10 comprises FIGS. 10A-10B. FIG. 10A is a graph illustrating water and salt permeance of patterned TFC membranes as a function of time at various conditions. FIG. 10B is a graph illustrating water and salt permeance of non-patterned TFC membranes as a function of time at various conditions. In the graphs, A=water; B=salt.

FIG. 11, comprising FIGS. 11A-11I, illustrates morphological characterization of the flat-NF, NIL-UF and NIL-NF membranes. Representative top-surface SEM images of (FIG. 11A) flat-NF membrane, (FIG. 11B) NIL-UF support membrane, (FIG. 11C) NIL-NF membrane. FIGS. 11D-11F illustrate representative topographic AFM images of respectively flat-NF, NIL-UF and NIL-NF membranes obtained from AFM scans. The corresponding cross-sectional profiles are illustrated in FIGS. 11G-11I. From FIG. 11H, groove depth is about 60 nm. From FIG. 11I, groove depth is about 30 nm.

FIG. 12 is a graph illustrating permeance decline during initial conditioning of three NIL-NF membrane replicates at 24 bar (about 350 psi).

FIG. 13, comprising FIGS. 13A-13E, is a set of graphs illustrating pressure-normalized volumetric flux during flat-NF and NIL-NF experiments at 12 bar and 24 bar. Initial pure water permeance of ESPA1 (a commercial membrane) was also included to compare compaction behavior. Confidence bars are 90% confidence intervals for three membrane replicates. Confidence intervals are displayed only for the last datum in each series for clarity reasons.

FIG. 14 is a graph illustrating separation factors between water (w), glycerol (r), and NaCl (e) for a variety of polymer material classes. Confidence bars are 90% confidence intervals for three membrane replicates. Crosses are NIL-NF; flat-bars are flat-NF; and the size of the symbol correlates with lower (12 bar) or higher (24 bar) transmembrane pressure (TMP) used. CA (cellulose acetate), PI (polyimide), SA-PA (semi-aromatic polyamide), and FA-PA (fully-aromatic polyamide).

FIG. 15, comprising FIGS. 15A-15B, is a set of graphs illustrating water permeance coefficient during BSA fouling (P_{w,+BSA}) normalized to water permeance coefficient prior to BSA addition (P_{w,no BSA}), as a function of time after BSA addition (t), for NIL-NF and flat-NF membranes at 12 and 24 bar (open and filled symbols, respectively). Confidence bars are 90% confidence intervals for three membrane replicates. FIG. 15A employs an expanded time scale to highlight the short time results.

### DETAILED DESCRIPTION OF THE INVENTION

The invention relates to unexpected discovery of a thin film membrane, and methods of making and using the same. The invention further relates to the discovery of a thin film composite (TFC) membrane, and methods of making and using the same.

In certain embodiments, the thin filtration membranes and TFC membranes of the invention show high permeate flux and rejection values when convection is present as a result of stirring. In other embodiments, the surface pattern induce hydrodynamic secondary flows at the membrane-feed interface, which are effective in decreasing concentration polarization as well as in reducing scaling effects. In yet other embodiments, the thin filtration membranes and TFC membranes of the invention provide an effective alternative to chemical modification for fouling mitigation for liquid-based separation membrane.

As reported herein, in a non-limiting example, a functional TFC membrane with well-controlled surface patterns was prepared. The two-step fabrication process consisted of forming a dense polyamide barrier layer using interfacial polymerization atop a nano-imprinted ultrafiltration support membrane. Systematic characterization of the patterned TFC membrane was carried out, showing that the TFC membranes of the invention have separation performances comparable with current commercial TFC RO/NF membranes. The comparison between the patterned and non-patterned TFC membrane indicated that surface patterns effectively mitigate concentration polarization and scaling.

As reported herein, permeation experiments were performed with these patterned and non-patterned composite membranes using aqueous NaCl/glycerol solutions, with and without bovine serum albumin (BSA) as a model protein foulant. The NaCl/glycerol/water fractionation properties of these membranes were not significantly affected by the imprinting process, and their separation performance was similar to that of commercially available materials. At a low transmembrane pressure with operation below the critical flux, the permeance decline was small in both imprinted and non-imprinted membranes. At a higher transmembrane pressure, however, a rapid flux decline was observed for the non-patterned membranes but not for the patterned ones. Furthermore, the patterned membranes recovered more of their initial pure water permeance after the fouling permeation experiments. These initial findings indicate improved long-term fouling mitigation due to surface patterning. In certain embodiments, about 30-nm protruding surface patterns increase the critical flux for protein deposition and also lead to a looser structure (and, thus, easier removal) of any deposited surface protein layer.

### DEFINITIONS

Unless defined otherwise, all technical and scientific terms used herein have the same meaning as commonly understood by one of ordinary skill in the art to which the invention pertains. Although any methods and materials similar or equivalent to those described herein may be used in the practice for testing of the invention, specific materials and methods are described herein. In describing and claiming the present invention, the following terminology will be used.

It is also to be understood that the terminology used herein is for the purpose of describing particular embodiments only, and is not intended to be limiting.

As used herein, the articles “a” and “an” are used to refer to one or to more than one (i.e., to at least one) of the grammatical object of the article. By way of example, “an element” means one element or more than one element.

As used herein when referring to a measurable value such as an amount, a temporal duration, and the like, the term “about” is meant to encompass variations of ±20% or ±10%, more preferably ±5%, even more preferably ±1%, and still more preferably ±0.1% from the specified value, as such variations are appropriate to perform the disclosed methods.

As used herein, the term “concentric lines” refers to lines that share the same center or axis. Examples include but are not limited to circles, regular polygons, regular polyhedral, spheres, and cylinders.

As used herein, the term “flat-NF” refers to TFC membranes fabricated on a flat, unaltered UF substrate.

As used herein, the term “fluid” refers to a liquid or a gas.

As used herein, the term “flux” is used to refer to the volume of fluid (such as a solution) flowing through a given membrane area during a given time. As used herein, the term “critical flux” is used to refer to the permeate flux of a membrane system below which no fouling occurs. Ideally, for a clean system, water flux for a membrane is proportional to the applied transmembrane pressure (TMP). When flux passes its critical value, irreversible deposits and/or fouling start to begin, and flux starts to deviate from the linear relationship with TMP. From the concept of critical flux, when the membrane runs at a pressure lower than the corresponding pressure of critical flux it is defined as operating in the “sub-critical flux” zone. Subsequently, when a membrane runs at a pressure higher than the critical flux pressure it is operating in the “super-critical flux” zone. Theoretically, when the membrane operates in the sub-critical flux zone, the particle-membrane repulsive force and/or the subsequent back diffusion is higher than the permeate drag force. At this region the membrane flux remains constant over time.

As used herein, the term “FTIR-ATR” refers to total reflectance Fourier transform infrared spectroscopy.

As used herein, the term “interfacial polymerization” refers to a condensation polymerization reaction between at least two monomers, wherein each monomer is dissolved in a distinct solvent, wherein the distinct solvents are immiscible, one of which is preferably water.

As used herein, the “intersecting lines” refers to lines that meet at one or more points.

As used herein, the term “line-to-space ratio” refers to the width of the raised-to-depressed regions of a regular pattern.

As used herein, a “membrane” is a barrier separating two fluids, wherein the membrane allows species-selective transport between the fluids.

As used herein, the term “molecular weight cut off” or “MWCO” refers to the molecular weight of a component with about 90%, about 95% or about 99% membrane retention.

As used herein, the term “nanoimprint” refers to nanolithographically fabricating nanometer-scale structures, also defined as patterns with at least one dimension between the size of an individual atom and approximately 1,000 nm.

As used herein, the term “nanoscale” refers to the size of objects ranging from about 1 nm to about 1,000 nm.

As used herein, the term “NF” refers to nanofiltration.

As used herein, the term “NIL-NF” refers to composite membranes fabricated on nanoimprinted UF substrates.

As used herein, the term “periodicity” refers to the distance or space between features in a pattern on a membrane. Such features, for example, can be ridges, valleys, channels, hills, posts, peaks, needles, pins, knobs, parallel lines, intersecting lines and/or concentric lines on the membrane.

As used herein, the term “portion” as applied to an element (such as, but not limited to, a dimension, a surface or a volume) refers to a fraction of the element, wherein the fraction varies from about 0.001% to 100%. In certain embodiment, the portion of the element is about 100% of the element. In other embodiments, the portion of the element is less than about 100% of the element. All fractions of the element are contemplated herein.

As used herein, the term “repeating pattern” refers to a pattern that repeats itself in a regular spatial interval throughout a surface or volume. The repeating pattern is thus distinct from a random pattern, which repeats itself at random intervals or does not repeat itself at all. In certain embodiments, a pattern is a repeating pattern even if the pattern presents a level of local variability, wherein the level is equal to or less than about 25%, 20%, 15%, 10%, 5%, 2.5%, 1%, 0.5%, 0.1%, 0.05% or 0.01%.

As used herein, the term “RO” refers to reverse osmosis.

As used herein, the term “TFC” refers to thin film composite.

As used herein, the term “TMP” refers to transmembrane pressure.

As used herein, the term “ultrafiltration” or “UF” as applied to membranes refer to those with a molecular weight cut off (MWCO) ranging from about 1 and about 1,000 kDa.

As used herein, the term “working area” refers to the area or portion of membrane used to filter fluid.

### DISCLOSURE

In one aspect, the invention provides a thin film membrane having a first surface and a second surface counterfacing the first surface. In another aspect, the invention provides a thin film composite (TFC) membrane.

In certain embodiments, the TFC membrane comprises a thin film membrane that is on at least a portion of a surface of a nanopatterned microporous membrane support layer. In other embodiments, the thin film membrane is prepared (i.e., partially or completely polymerized), coated, or deposited onto at least a portion of a surface of a nanopatterned microporous membrane support layer. In yet other embodiments, the support layer comprises at least one filtration membrane selected from the group consisting of an ultrafiltration membrane, a nanofiltration membrane, a microfiltration membrane and a reverse osmosis membrane. In yet other embodiments, the nanopatterned microporous membrane support layer is also known as base membrane.

In certain embodiments, the thin film membrane and/or TFC membrane of the invention comprises at least one material selected from the group consisting of cellulose acetate, polysulfone, polyethersulfone, ionic liquid, self-assembled monolayers, rubbery polymer (such as a polymeric organosilicon compound or silicone, such as but not limited to PDMS), and any substituted derivatives thereof. In other embodiments, the thin film membrane and/or TFC membrane of the invention comprises at least one material prepared by polymerization, such as but not limited to polyamides, polyaramids (polyaromatic amides), polyesters, polycarbonates, polycarbamates, polyimines, polyureas, polyalcohols, polyethers, polyphosphines, and their derivatized forms including sulfonates, carbonates and halides. In yet other embodiments, the thin film membrane and/or TFC membrane of the invention further comprises at least one material selected from the group consisting of dispersed nanoparticles (including but not limited to zeolites), metal organic frameworks, graphene flakes, graphene oxide flakes, metal oxides, carbon particles, silver, and zeolitic imidazolate frameworks. See Petersen, 1993, J. Membr. Sci. 83:81-150 for further materials contemplated or the preparation of thin film membranes and/or TFC membranes of the invention.

In certain embodiments, the thin film membrane and/or TFC membrane of the invention comprises a polyamide. In other embodiments, the thin film membrane and/or TFC membrane of the invention comprises a polymer prepared from monomers m-phenylenediamine and trimesoyl chloride.

In certain embodiments, the thin film membrane and/or TFC membrane of the invention further comprises a pattern on the first surface and/or the second surface, wherein the pattern covers at least a portion of the working area of the thin film membrane and/or TFC membrane of the invention. In certain embodiments, the pattern covers about 20-100% working area of the thin film membrane and/or TFC membrane of the invention. In other embodiments, the pattern covers about 100% working area of the thin film membrane and/or TFC membrane of the invention.

In certain embodiments, the pattern is a repeating pattern. The pattern of the invention can be a natural pattern or a non-natural pattern. Natural patterns include spirals, meanders, waves, foram, tilings, cracks, and symmetries of rotation and reflection. Non-natural patterns include any man-made shape, which may be formed by generating raised or depressed portions on the thin film membrane and/or TFC membrane of the invention. These shapes can include a series of ridges, valleys, channels, hills, posts, peaks, needles, pins, knobs, parallel lines, intersecting lines and concentric lines.

In certain embodiments, the periodicity of the pattern is in the range from about 10 nm to about 1,000 nm. In certain embodiments, the periodicity of the pattern is in the range from about 300 nm to about 500 nm. In certain embodiments, the periodicity of the pattern is about 834 nm.

In certain embodiments, the pattern comprises parallel lines. Each line forms a groove surrounded on one or both sides by a raised portion (projection). In certain embodiments, the pattern has a periodicity in a range from about 200 nm to 1000 nm; groove depth in a range from 5 nm to 300 nm; and a line-to-space ratio in a range from 1:1 to 1:5. In other embodiments, the pattern has a periodicity in a range from about 300 nm to 900 nm; groove depth in a range from 150 nm to 250 nm; and a line-to-space ratio in a range from 1:1 to 1:4. In yet other embodiments, the pattern has a periodicity in a range from about 400 nm to 800 nm; groove depth in a range from 175 nm to 225 nm; and a line-to-space ratio in a range from 1:1 to 1:3. In yet other embodiments, the pattern has a periodicity in a range from about 500 nm to 700 nm; groove depth in a range from 180 nm to 220 nm; and a line-to-space ratio in a range from 1:1 to 1:2. In yet other embodiments, the pattern has a periodicity in a range about 834 nm; groove depth about 200 nm; and a line-to-space ratio about 1:1.

In certain embodiments, the pattern comprises parallel lines and intersecting lines. Each line forms a groove surrounded on one or both sides by a raised portion (projection). In certain embodiments, the intersecting lines have a periodicity in a range from about 200 nm to 1000 nm; groove depth in a range from 5 nm to 300 nm; and a line-to-space ratio in a range from 1:1 to 1:5. In other embodiments, the intersecting lines have a periodicity in a range from about 300 nm to 900 nm; groove depth in a range from 150 nm to 250 nm; and a line-to-space ratio in a range from 1:1 to 1:4. In yet other embodiments, the intersecting lines have a periodicity in a range from about 400 nm to 800 nm; groove depth in a range from 175 nm to 225 nm; and a line-to-space ratio in a range from 1:1 to 1:3. In yet other embodiments, the intersecting lines have a periodicity in a range from about 500 nm to 700 nm; groove depth in a range from 180 nm to 220 nm; and a line-to-space ratio in a range from 1:1 to 1:2.

In certain embodiments, the pattern comprises parallel lines, intersecting lines, and concentric lines. Each line forms a groove surrounded on one or both sides by a raised portion (projection). In certain embodiments, the concentric lines have a periodicity in a range from about 200 nm to 1,000 nm; groove depth in a range from 5 nm to 300 nm; and a line-to-space ratio in a range from 1:1 to 1:5. In other embodiments, the concentric lines have a periodicity in a range from about 300 nm to 900 nm; groove depth in a range from 150 nm to 250 nm; and a line-to-space ratio in a range from 1:1 to 1:4. In yet other embodiments, the concentric lines have a periodicity in a range from about 400 nm to 800 nm; groove depth in a range from 175 nm to 225 nm; and a line-to-space ratio in a range from 1:1 to 1:3. In yet other embodiments, the concentric lines have a periodicity in a range from about 500 nm to 700 nm; groove depth in a range from 180 nm to 220 nm; and a line-to-space ratio in a range from 1:1 to 1:2.

In certain embodiments, the pattern comprises parallel ridges. In other embodiments, the pattern of the invention comprises parallel ridges and additional ridges that intersect the parallel ridges. In yet other embodiments, the additional ridges are parallel to each other. In yet other embodiments, the additional ridges are about perpendicular to the the original parallel ridges. In yet other embodiments, the additional ridges intersect the said original parallel ridges at an angle of between about 0.01 and 90°.

In certain embodiments, the pattern comprises of a series of parallel ridges or projections. Each of these ridges or projections forms peaks when the membrane is viewed in profile, and the space between them forms valleys. In certain embodiments, the average distance between each peak, also defined as the period or periodicity, is between about 10 and 2000 nm. In other embodiments, the average distance between each peak is about 10, 20, 30, 50, 75, 100, 150, 200, 250, 300, 350, 400, 450, 500, 550, 600, 650, 700, 750, 800, 850, 900, 950, 1000, 1050, 1100, 1150, 1200, 1250, 1300, 1350, 1400, 1500 or 2000 nm. In yet other embodiments, the periodicity is between 600 and 800 nm. In yet other embodiments, the periodicity is, on average, about 834 nm.

As described herein, a valley width refers to the average lateral distance between two points on the membrane at the average height of the membrane when viewed in profile. In certain embodiments, the average valley width is between about 10 and about 800 nm. In other embodiments, the average valley width is about 10, 50, 100, 150, 200, 250, 300, 350, 400, 450, 500, 550, 600, 650, 700, 750 or 800 nm.

In certain embodiments, the depth of the valley is between 10 and 600 nm. In other embodiments, the average amplitude of the valley is about 10, 20, 30, 50, 100, 150, 200, 250, 300, 350, 400, 450, 500, 550 or 600 nm.

Different sized patterns can be used to filter different sized particles. In certain embodiments, the average valley width and/or depth of the membrane is smaller than the average particle size to be filtered. In certain embodiments, the average valley width and/or depth is 99% of the average particle size to be filtered. In other embodiments, the average valley width and/or depth is about 120, 110, 100, 95, 90, 85, 80, 75, 70, 65, 60, 55 or 50% of the average particle size to be filtered.

Generation of a pattern on a surface of a membrane can be performed using any method known in the art. In certain embodiments, the membranes are patterned by nanolithography, which creates nanoscale shapes on the surface of a membrane.

In certain embodiments, the thin film membrane and/or TFC membrane of the invention is a gas or vapor separation membrane, a nanofiltration membrane, or a reverse osmosis membrane. In certain embodiments, a nanofiltration membrane can reject solutes 0.5-10 nm or larger in size. In other embodiments, a microfiltration membrane has an effective pore size ranging from about 45 nm to about 2,500 nm. In yet other embodiments, an ultrafiltration (UF) membrane has an effective pore size ranging from about 2.5 to about 120 nm.

In certain embodiments, the thin film membrane and/or TFC membrane of the invention is combined with yet another filtration membrane, which can be an ultrafiltration membrane, a nanofiltration membrane, a microfiltration membrane or a reverse osmosis membrane.

In another aspect, the invention includes a TFC membrane comprising a base membrane; a thin film membrane on the base membrane; and a repeating pattern covering both the base membrane and the thin film membrane, and with periodicity not exceeding 1 micrometer in size.

The base membrane functions as a support to the TFC membrane of the invention in addition to filtration. In certain embodiments, the base membrane comprises a polymer selected consisting of nylon, mixed cellulose esters, regenerated cellulose, cellulose acetate, polycarbonate, polytetrafluoroethylenes, polypropylene, polystyrene, polyvinylchloride, polysulfone, poly (ether sulfone), and polyethylene. In other embodiments, the base membrane comprises poly (ether sulfone) (PES).

In certain embodiments, the base membrane can be an ultrafiltration membrane, a nanofiltration membrane, a microfiltration membrane or a reverse osmosis membrane. In other embodiments, the base membrane is an ultrafiltration membrane.

Base membranes useful for ultrafiltration include materials such as poly (ether sulfone), polyacrylonitrile, polyvinylidene, regenerated cellulose, cellulose acetate, polysulfone, polypropylene, polyaryl ether sulfones, polyvinylidene fluoride, polyvinyl chloride, polyketones, polyether ketones, polytetrafluoroethylene, polyimides, and/or polyamides, and any combinations thereof.

Base membranes useful for nanofiltration include materials such as cellulose acetate, polypiperazine amide, polyamides, polyethylene, polypropylene, polysulfones, poly (ether sulfone), polytetrafluoroethylene, polyvinylidenedifluoride, polyimides and/or polyacrylonitriles, and any combinations thereof.

Base membranes useful for microfiltration include materials such as nylon, mixed cellulose esters, regenerated cellulose, cellulose acetate, polycarbonate, polytetrafluoroethylenes, polypropylene, polystyrene, polyvinylchloride, polysulfone, poly (ether sulfone), and/or polyethylene, and combinations thereof.

Base membranes useful for reverse osmosis include materials such as cellulose acetates, polypiperazine amide, and polyamides. Embodiments herein may include one or more of: poly(methyl methacryiate), polystyrenes, polycarbonates, polyimides, epoxy resins, cyclic olefin copolymers, cyclic olefin polymers, acrylate or methacryiate polymers, polyethylene terephthalate, polyphenylene vinylene, polyether ether ketone, poly (N-vinylcarbazole), acrylonitrile-styrene copolymer, polyetherimide, poly(phenylenevinylene), polysulfones, sulfonated polysulfones, copolymers of styrene and acrylonitrile, poly(tetrafluoroethylene), poly(ethylene-co-propylene-co-diene), poly(arylene oxide), polycarbonate, cellulose acetate, piperazine-containing polymers, poly electrolytes, styrene-containing copolymers, acrylonitrilestyrene copolymers, styrene-butadiene copolymers, styrene-vinylbenzylhalide copolymers, cellulosic polymers, cellulose acetate-butyrate, cellulose propionate, ethyl cellulose, methyl cellulose, nitrocellulose, polyamides, polyimides, aryl polyamides, aryl polyimides, polyethers, poly(arylene oxides), poly(phenylene oxide), poly(xylene oxide), poly(esteramide-diisocyanate), polyurethanes, polyesters (including polyarylates), poly(alkyl methacrylates), poly(acrylates), poly(phenylene terephthalate), polysulfides, poly(ethylene), poly(propylene), poly(butene-1), poly(4-methyl pentene-1), polyvinyls, poly(vinyl chloride), poly(vinyl fluoride), poly(vinylidene chloride), poly(vinylidene fluoride), polyvinyl alcohol), polyvinyl esters), poly(vinyl acetate), poly(vinyl propionate), polyvinyl pyridines), polyvinyl pyrrolidones), poly(vinyl ethers), poly(vinyl ketones), poly(vinyl aldehydes), poly(vinyl formal), poly(vinyl butyral), polyvinyl amides), polyvinyl amines), polyvinyl urethanes), polyvinyl ureas), polyvinyl phosphates), polyvinyl sulfates), polyallyls; poly(benzobenzimidazole), polyhydrazides, polyoxadiazoles, polytriazoles, poly (benzimidazole), polycarbodiimides, polyphosphazines and combinations thereof.

In certain embodiments, the base membrane comprises a PES ultrafiltration membrane.

In certain embodiments, the descriptions and limitations about a pattern on a thin film membrane as described elsewhere herein are applicable to the TFC membrane, and vice-versa.

### Methods of Making

In one aspect, the invention relates to a method of making a TFC membrane comprising a base membrane; a thin film membrane on a portion of the base membrane; and a pattern covering both the base membrane and the thin film membrane, and with periodicity not exceeding 1 micrometer in size. In certain embodiments, the method comprises nanoimprinting a base membrane with a pattern. In other embodiments, the method comprises preparing a thin film membrane atop a portion of the base membrane using interfacial polymerization. In yet embodiments, the thin film membrane is then physically separated from the base membrane, using methods such as sonication, drying, solvent softening and/or mechanical pulling.

Nanoimprinting as used herein refers to nanoimprint lithography (NIL). The NIL used can be embossing NIL or step-and-flash NIL. When embossing NIL is used, in certain embodiments, the membrane is applied to a rigid mold including the pattern to be placed on the membrane under pressure and increased temperature for a certain period of time. The pressure is then released, and the temperature lowered. Then, the membrane is separated from the mold, resulting in the pattern from the mold being embossed on the membrane. In certain embodiments, the rigid mold is made of silicon, while in other embodiments the rigid mold is made of polymer, metal, glass, ceramic, composite or combinations thereof. The mold may be made of a very hard and thermally stable polymer. In certain embodiments, the temperature is increased to above a glass transition temperature of the membrane. In other embodiments, the membrane is not heated to the glass transition temperature of the membrane. Temperatures used to emboss a pattern onto a membrane can range between about 50 and 200° C. In other embodiments, the temperatures are about 50, 60, 70, 80, 90, 100, 110, 120, 130, 140, 150, 160, 170, 180, 190 or 200° C. In yet other embodiments, the pressure is applied to emboss the pattern on the membrane from the mold. In yet other embodiments, the pressure is about 1-10 MPa. In yet other embodiments, the pressure is about 1, 2, 3, 4, 5, 6, 7, 8, 9 or 10 MPa.

In certain embodiments, the membrane and mold are exposed to increased temperature and pressure for between about 1 second and 10 minutes. In other embodiments, the membrane and mold are exposed to increased temperature and pressure for about 1, 5, 10, 20, 30, 60, 90, 120, 150, 180, 210, 240, 270, 300, 330, 360, 390, 420, 450, 480, 510, 540, 570 and 600 seconds.

In certain embodiments, the temperature is decreased to below the glass transition temperature of the membrane after the pattern is embossed onto the membrane from the mold. In other embodiments, the membrane is not heated above the glass transition temperature. Decreased temperatures used to emboss a pattern onto a membrane can range between about 25 and 100° C. In other embodiments, the temperature is about 25, 10 30, 40, 50, 60, 70, 80, 90 or 100° C.

In other embodiments, a method produces a patterned base membrane using thermal embossing NIL. The method includes providing a base membrane; pressurizing the membrane in a rigid mold under a pressure of about 3-7 MPa (e.g., around 4 MPa for certain materials); heating the membrane to a temperature higher than the glass transition temperature of the membrane (e.g., between 100 and 150° C. for certain materials); cooling the membrane to a temperature lower than the glass transition temperature of the membrane (e.g., to about 40° C. for certain materials); and separating the membrane from the mold to produce the patterned membrane. The pressurizing and heating steps may be performed, for example, in about 180 seconds.

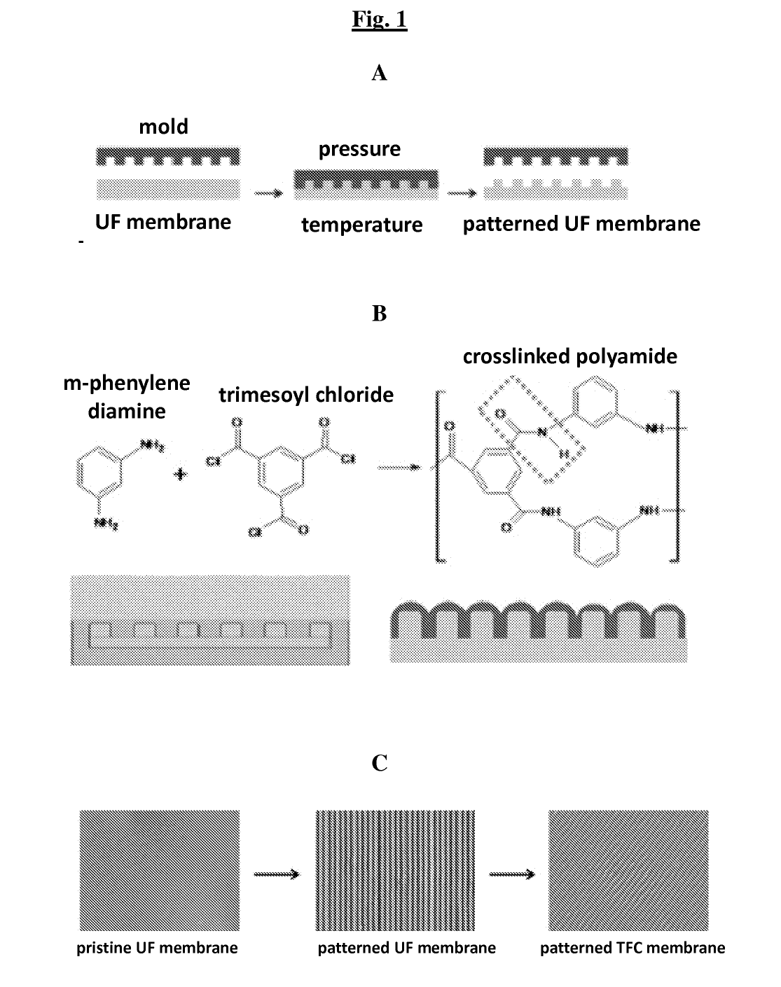

The pattern on a base membrane can be generated using any method known in the art. In certain embodiments, the pattern is generated by nanolithography, which creates nanoscale shapes on the surface of a membrane. In certain embodiments, the pattern is initially generated on a base membrane using nanolithography, then a TFC membrane is formed using interfacial polymerization atop the patterned base membrane as shown in FIG. 1B, resulting the same pattern covering the TFC membrane.

An interfacial polymerization reaction refers to a reaction wherein organic monomers are dissolved in mutually immiscible solvent, and a condensation product is formed at the interface of the immiscible phases. In certain embodiments, interfacial polymerization of these organic monomers provide faster polymerization rates than other types of polymerization reactions such as bulk or solution polymerizations. In other embodiments, high molecular weight polymers are obtained because stoichiometry between the monomers need not be precise.

In certain embodiments, the monomers for making the TFC membrane on the base membrane are m-phenylenediamine and trimesoyl chloride.

### Method of Using

In one aspect, the thin film membranes and/or TFC membranes of the invention can be used to filter a solute from a fluid. The filtration can be performed by passing the fluid through the thin film membranes and/or TFC membranes of the invention. In certain embodiments, the fluid is a solution comprising one or more solutes and one or more solvents. In other embodiments, the fluid is a liquid such as a polar or non-polar solvent. A polar solvent may be one or more of water, dichloromethane, tetrahydrofuran, ethyl acetate, acetone, dimethylformamide, acetonitrile, dimethyl sulfoxide, propylene carbonate, formic acid, n-butanol, isopropanol, n-propanol, ethanol, methanol and acetic acid. A non-polar solvent may be one or more of pentane, cyclopentane, hexane, cyclohexane, benzene, toluene, 1,4-dioxane, chloroform, and diethyl ether. In other embodiments, the fluid is a gas.

In certain embodiments, the thin film membranes and/or TFC membranes of the invention are used for pretreatment of process water and post treatment for ultrapure water. In other embodiments, the thin film membranes and/or TFC membranes of the invention are capable of filtering components such as high molecular-weight substances, colloidal materials, proteins and viruses.

In certain embodiments, the thin film membranes and/or TFC membranes of the invention are used to remove particles from solvents. The particles can be of various sizes. In certain embodiments, the particles are, on average, between about 10 and 1510 nm. In other embodiments, the particles are, on average, about 10, 20, 30, 50, 75, 100, 125, 150, 200, 250, 300, 350, 400, 450, 500, 550, 600, 650, 700, 750, 800, 850, 900, 950, 1000, 1050, 1100, 1150, 1200, 1250, 1300, 1350, 1400, 1450, 1500 or 1510 nm in diameter. In yet other embodiments, the particles are between 1 and 1000 kDa in mass. In yet other embodiments, the particles are about 0.1, 1, 50, 100, 150, 200, 250, 300, 350, 400, 450, 500, 550, 600, 650, 700, 750, 800, 850, 900, 950, or 1000 kDa in mass. According to the methods of filtration described herein, filtration can be performed at any temperature. In certain embodiments, filtration is performed at room temperature (e.g., between 18 and 25° C.). In other embodiments, filtration is performed between about 1 and 50° C. In yet other embodiments, filtration is performed at about 1, 5, 10, 15, 20, 25, 30, 35, 40, 45 or 50° C.

According to certain embodiments, filtration is performed at a sub-critical flux. Examples of potential sub-critical fluxes for different particle sizes and membrane valley widths are described in the PCT Application Publication No. PCT/US13/58609.

According to the methods of filtration described herein, filtration can be performed at any pressure. In certain embodiments, filtration is performed at between about 6 and 51 psi. In other embodiments, filtration is performed at about 6, 10, 15, 20, 25, 30, 35, 40, 45, 50 or 51 psi.

A particular embodiment includes a method of filtering a component with a molecular weight of between about 0.1 and 1,000 kDa from an aqueous solution. The method includes passing the aqueous solution containing the component through a filtration membrane complex as disclosed herein. In certain embodiments, this method is performed at a sub-critical flux. In other embodiments, the sub-critical flux is above 40 L m⁻² h⁻¹. In yet other embodiments, the critical flux may be between 40 and 60 L m⁻² h⁻¹ or between 60 and 90 L m⁻² h⁻¹. In yet other embodiments, the critical flux is above 60 L m⁻² h⁻¹ when the component has an average particle size of 500 nm in diameter.

An embodiment includes a method of filtering a component with a molecular weight of between 0.1 and 1,000 kDa from an aqueous solution. The method includes passing the aqueous solution containing the component through a membrane as disclosed herein, wherein the critical flux is between 5-90 L m⁻² h⁻¹ when the component has an average aqueous diffusion coefficient at 298 K between 4×10⁻¹³ m²/s to 4×10⁻⁹ m²/s.

Those skilled in the art will recognize, or be able to ascertain using no more than routine experimentation, numerous equivalents to the specific procedures, embodiments, claims, and examples described herein. Such equivalents were considered to be within the scope of this invention and covered by the claims appended hereto. For example, it should be understood, that modifications in reaction conditions, including but not limited to reaction times, reaction size/volume, and experimental reagents, such as solvents, catalysts, pressures, atmospheric conditions, e.g., nitrogen atmosphere, and reducing/oxidizing agents, with art-recognized alternatives and using no more than routine experimentation, are within the scope of the present application.

It is to be understood that wherever values and ranges are provided herein, all values and ranges encompassed by these values and ranges, are meant to be encompassed within the scope of the invention. Moreover, all values that fall within these ranges, as well as the upper or lower limits of a range of values, are also contemplated by the present application.

The following examples further illustrate aspects of the invention. However, they are in no way a limitation of the teachings or disclosure of the invention as set forth herein.

### EXAMPLES

The invention is now described with reference to the following Examples. These Examples are provided for the purpose of illustration only and the invention should in no way be construed as being limited to these Examples, but rather should be construed to encompass any and all variations which become evident as a result of the teaching provided herein.

### Methods for Membrane Characterization

### Determining Membrane Resistance:

At the start of each experiment, deionized water was filtered through the membrane for about 200 min to allow for complete membrane compaction and other unknown causes of flux decline inherent to laboratory-scale recirculation systems. After achieving the stable flux in about 150 to 170 min, the membrane hydraulic resistance was determined by measuring pure water flux over a range of applied pressures (689.47-2,757.90 kPa). The relationship governing the experimental pure water flux is

$${J}_{( v ) {H}_{2} O} = \frac{Δ P}{μ ( {R}_{m} )} , \qquad ( 1 )$$

wherein
J_{(v)H}_{₂}_{O} is the flux without presence of salt or electrolyte (m³/m²/s), ΔP is the transmembrane pressure (Pa), μ is the viscosity of water (Pa·s), and Rₘ is the membrane resistance (1/m). From (1), membrane resistance was determined for both patterned TFC membrane and non-patterned TFC membrane by a linear regression of the measured pure water flux and applied pressure data.

### Determining Transmembrane Osmotic Pressure:

After DI water filtration, electrolyte was added to obtain the desired feed ionic strength for the separation experiment. Flux and stirring were set at the desired values for each of the salt filtration experiment and the system was allowed to equilibrate to ensure stable performance. Due to concentration polarization of rejected ionic constituents, the driving force for permeation is the difference between the applied pressure (ΔP) and the transmembrane osmotic pressure at the membrane interface (Δπₘ). Thus, the permeate flux with presence of salt is described by

$${J}_{( v ) salt} = \frac{Δ P - {Δπ}_{m}}{μ ( {R}_{m} )} , \qquad ( 2 )$$

wherein:
Jᵥ₍ₛₐₗₜ₎ is the flux with the presence of salt or electrolyte (m³/m²/s), and Δπₘ is the transmembrane osmotic pressure (Pa),

(Δπₘ=Δπ_{b}−Δπ_{cp};Δπ_{b}=π_{b}−πₚ;Δπ_{cp}=π_{b}−πₘ).

Filtration was performed for 25 min to remove trapped air and to allow concentration polarization to develop but to minimize the change in the bulk electrolyte solution composition. About 78 ml of permeate was then collected to determine flux and composition, and to use in the aforementioned to determine the transmembrane osmotic pressure at that particular phase of the experiment. However, transmembrane osmotic pressure for NaCl solution can also be estimated using van′t hoff's equation

Δπₘ=iRTΔc (3),

wherein
i is the dimensionless vant hoff's factor, R is the universal gas constant, T is the temperature, and Δc is the concentration gradient between feed side and permeate side. From the comparison of the composition-based osmotic pressure and experimental osmotic pressure the concentration polarization can be calculated and also the module's mass transfer coefficient and intrinsic salt rejection can be estimated (Peeva, et al., 2004, J. Membr. Sci. 236:121-136).

### Determining Intrinsic Salt Rejection

The film model is based on a mass balance over an element of the boundary layer and allows the concentration at the membrane surface to be calculated from the mass-transfer coefficient

$${j}_{i , v} = \frac{{D}_{i}}{{δ}_{i}} ln [ \frac{( {c}_{i , m} - {c}_{i , p} )}{( {c}_{i , b} - {c}_{i , p} )} ] = {k}_{i} ln [ \frac{( {c}_{i , m} - {c}_{i , p} )}{( {c}_{i , b} - {c}_{i , p} )} ] , \qquad ( 4 )$$

wherein
j_{i,v} is the total volumetric flux, Dᵢ is the diffusivity of solute i in water, δᵢ is the thickness of the boundary layer, c_{i,m} is the concentration in solution at the feed-membrane interface, c_{i,p} is the permeate concentration, c_{i,b} is the bulk concentration, and kᵢkᵢ is the mass-transfer coefficient. All cᵢ values refer to the concentration in solution. At any time, the intrinsic rejection R depends on the actual solute concentration prevailing on the membrane surface and is given by:

$$R = \frac{( {c}_{i , m} - {c}_{i , p} )}{{c}_{i , m}} \qquad ( 5 )$$

While the observed rejection is based on the solute bulk concentrations and is given by

$${R}_{0} = \frac{( {c}_{i , b} - {c}_{i , p} )}{{c}_{i , b}} \qquad ( 6 )$$

The two rejections are related by the following:

$$ln ( \frac{1 - {R}_{0}}{{R}_{0}} ) - ln ( \frac{1 - R}{R} ) = \frac{{J}_{v}}{k} \qquad ( 7 )$$

Sutzkover et al. (Sutzkover, et al., 2000, Desalination 131:117-127) described a simple technique for estimating Jᵥ/k in a differential reverse osmosis system. Their technique is based on evaluating the reduction in the permeate flux when salt solution is introduced instead of pure water. The net driving force is influenced by the changes in the osmotic pressure and assessment of the magnitude of the flux decline enables the evaluation of the membrane surface concentration. The mass transfer coefficient is given by:

$$k = \frac{{J}_{( v ) salt}}{ln \{ \frac{Δ P}{{π}_{b} - {π}_{p}} \cdot [ 1 - \frac{{J}_{( v ) salt}}{{J}_{( v ) {H}_{2} O}} ] \}} or$$

$$\frac{{J}_{v , salt}}{k} = ln \{ \frac{Δ P}{{π}_{b} - {π}_{p}} \cdot [ 1 - \frac{{J}_{v , salt}}{{J}_{v , {pureH}_{2} O}} ] \} = ln ( \frac{1 - {R}_{o}}{{R}_{o}} \cdot \frac{R}{1 - R} )$$

Hence, the value of R can be simply determined from the osmotic pressures π_{b} and πₚ of the saline feed and permeate, the observed rejections, and by measuring J_{(v) H2O}, the permeate flux of the salt-free water at the same applied pressure, and Jᵥ(t), the permeate flux of the saline solution, all at any time t.

### Determination of Salt and Water Permeation

The functional permeance of water (represented as A) and salt (B) can be extracted from the filtration experiments as follows.

A=J₍ᵥ₎ₛₐₗₜ/(ΔP−Δ) (9)

and,

B=cₚJ₍ᵥ₎ₛₐₗₜ/(cₘ−cₚ) (10)

where J_{w} is the flux, cₚ and cₘ are the solute concentration in the permeate and feed side at the membrane surface, respectively, ΔP is the applied filtration pressure, and Δπ is the osmotic pressure across the membrane. The only unknown quantity, cₘ, is estimated from,

$${c}_{m} = {c}_{b} \frac{exp ( {J}_{w} / k )}{R + ( 1 - R ) exp ( {J}_{w} / k )} \qquad ( 11 )$$

where C_{b} is the bulk feed solution concentration taken as the arithmetic average between the feed and reject compositions, R is the membrane intrinsic salt rejection and k is the mass-transfer coefficient obtained for the system previously

### Example 1

### Attenuated Total Reflectance-Fourier Transform Infrared

Attenuated Total Reflectance-Fourier transform infrared (ATR-FTIR) spectroscopy (Nicolet 6700 FT1R spectrometer, Thermo Fisher Scientific, equipped with a diamond ATR crystal) was used to characterize the polyamide barrier layers. Both the PES UF membrane support and the corresponding TFC membranes (after the IP process) were measured. Three replicate ATR-FT1R spectra were obtained for each membrane sample with each spectrum averaged from 128 scans collected from 700 to 2,200 cm⁻¹ at 1 cm⁻¹ resolution. Membrane samples were extensively rinsed and soaked in DI water for 24 h before they were dried in a vacuum oven prior to the ATR-FTIR measurements.

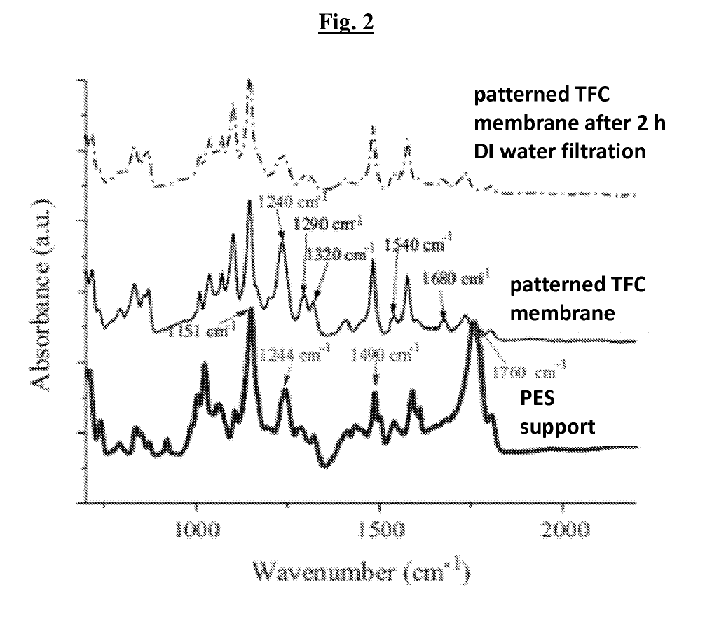

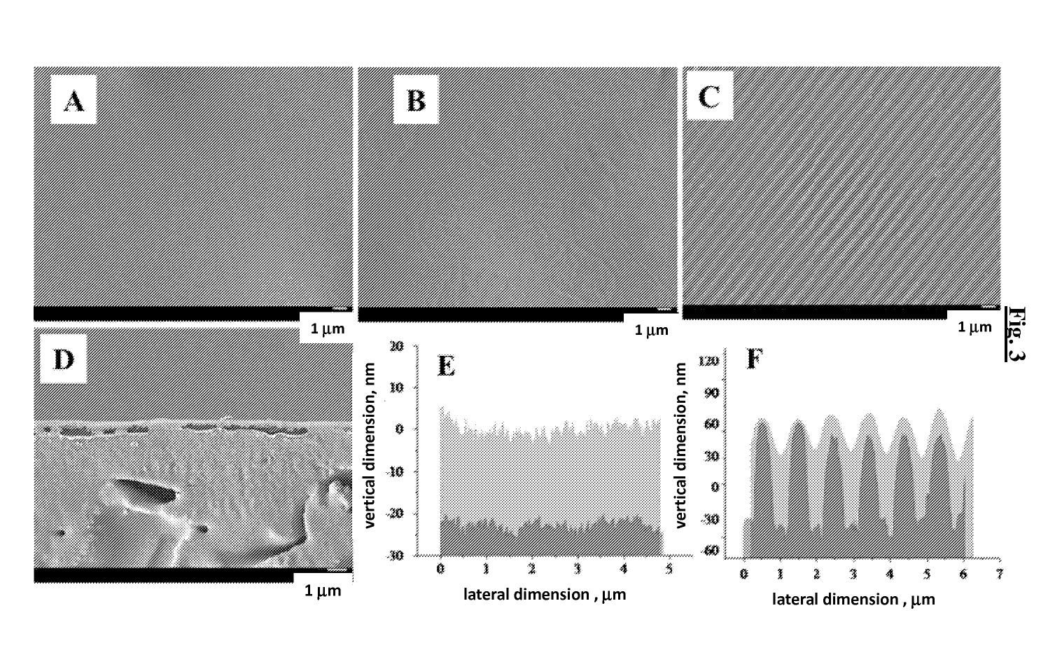

The FTIR spectra of the surfaces of the imprinted PES UF substrate with (patterned TFC membrane) and without (support only) the IP dense layer were compared in FIG. 2. The IR spectrum of a non-patterned TFC membrane was not included in the figure since it was identical to that of the patterned TFC membrane. For the patterned PES UF membrane, the strong absorption band at 1760 cm⁻¹ represented C═O stretching. The sharp absorption peaks at 1,151, 1,244, and 1,490 cm⁻¹ were ascribed to the symmetrical stretching vibration of the SO₂ group, C—O—C vibrations, and C—S vibration, respectively. All of these characteristic peaks were consistent with the chemical structure of PES. Because the calculated penetration depth of the ATR-FTIR spectroscopy was about 1-5 nm in the wavelength region of interest, the IR spectrum of the TFC membrane surface shown in FIG. 2 was necessarily a combination of the polyamide barrier layer and the underlying PES support. The vibrational signatures associated with the polyamide layer include the new peaks around 1,240, 1,290 and 1,320 cm⁻¹ corresponding to stretching of aromatic amines I, II and III, respectively, as well as those at about 1,540 and 1,680 cm⁻¹ representing stretching of amides I and II, respectively (Coates, J., 2000, Interpretation of infrared spectra, a practical approach, Encyclopedia of Analytical Chemistry, John Wiley and Sons Ltd., UK, Chicester; Silverstein, et al., 1998, Spectrometric Identification of Organic Compounds, Wiley).

The observed aromatic amines were possibly originated from both absorbed unreacted MPD monomers in the membrane and unreacted amine groups bonded on the polyamide network.

To leach out the physically absorbed MPD, DI water filtration on the as-prepared patterned TFC membrane was carried out at 2.76 MPa for 2 h. The FTIR spectrum of the membrane after the filtration showed that the intensity of the amine peaks was reduced appreciably, but still reasonably strong (FIG. 2). This confirms that both contributions mentioned above were present in the as-prepared TFC membranes. Nonetheless, FTIR measurements confirmed the formation of polyamide barrier layers on both the patterned and non-patterned UF membrane.

### Example 2

### Scanning Electron Microscope

Surface topography and cross-sections of the membranes, before and after fabrication, were examined with a field-emission scanning electron microscope (FESEM, Zeiss, Supra 60) and an atomic force microscopy (AFM, Dimension 3100 AFM, Bruker). Membrane samples were dried in a vacuum oven prior to SEM measurements, and the membrane cross-sections were prepared using a microtome at −20° C., and coated with a 4.7 nm gold layer. All AFM measurements were performed with the tapping mode under ambient conditions using silicon cantilever probe tips (Veeco, RTESP).

FIG. 3 summarizes the morphological characterization of the patterned and non-patterned PES UF support membrane and the corresponding TFC membranes. The non-patterned UF membrane (FIG. 3A) had a smooth surface with an RMS roughness of less than 10 nm as determined from the AFM surface profile shown in FIG. 3C. After the imprinting process, periodic line-and-space grating patterns (FIG. 3D) with an average pattern height ˜100-120 nm were present in the patterned UF membrane (FIG. 3F). In addition, the imprinting process apparently increased the density of the porous PES support as inferred by a decrease in the MWCO of the membrane from 15.4 to 9.20 kg/mol. However, the DI water flux was quite similar for the non-patterned and patterned UF membranes most likely due to the increased actual (versus projected) surface area after imprinting.

An IP process was used to form a polyamide layer on both non-patterned and patterned UF membranes. In FIG. 3B the surface of the non-patterned TFC membrane appeared very smooth, which was confirmed from the AFM measurement which showed an RMS roughness of ˜14 nm (FIG. 3C). This surface topography is notably different from the much rougher, “ridge-and-valley” structure of the typical aromatic crosslinked polyamide films. However, TFC membranes with relatively smooth crosslinked polyamide barrier layers are known (Song, et al, 2005, J. Appl. Polym. Sci. 95:1251-1261). The ridge-and-valley structure develops from the growth of the stiff aromatic polyamide chains perpendicularly to the organic solvent/aqueous phase interface, and becomes significant only when the overall barrier layer grows above a certain thickness (over ˜100 nm). Here, the thickness of the polyamide film on the non-patterned TFC membrane was determined as only about 40 nm using an AFM scan on the isolated barrier layer on a Si wafer (FIG. 3C) using previously described techniques (Maruf, et al., 2011, Polymer 52:2643-2649). This relatively low value of barrier layer thickness might be caused by a combination of air blowing during the soaking of the MPD solution and the short reaction time (8 s) used for the IP process. Indeed, reaction time (t) during IP is a known factor affecting the thickness of the polyamide layer as the film thickness increases as ˜t^{0.5} with a constant diffusion constant after a dense film has developed, and a shorter reaction time would be expected to yield a thinner polyamide film.

FIG. 3E shows the top surface morphology of the patterned TFC membrane. From AFM measurements (FIG. 3F), the patterned surfaces on the ridge and valley were even smoother than that of the non-patterned TFC membrane at the same sub-50 nm length scale. A denser porous substrate used for the IP process produces a smoother polyamide layer. As noted previously, the imprinted UF membrane was indeed denser than the non-patterned UF membrane, as determined from both cross-sectional SEM and MWCO measurements. In fact, the starting PW UF membrane (MWCO—15.4 kg/mol), approaches the lower limit of commercial UF membranes and may be even denser than the UF substrates commonly used in commercial TFC fabrication.

In certain embodiments, the overlay of the TFC layer on the patterned UF membrane shown in FIG. 3F is a schematic representation rather than an actual profile. As demonstrated herein, TFC membranes with periodic surface patterns on the surface were fabricated successfully.

### Example 3

### Fabrication of the Patterned TFC Membrane

Patterned TFC membranes were fabricated using a two-step process that consisted of (1) nanoimprinting a PES support, and (2) forming a thin dense film atop the PES support using interfacial polymerization (IP) process. A commercial PES UF membrane (PW, GE Water and Infrastructure) with a nominal 30 kg/mol molecular mass cutoff (MWCO) was used as the substrate on which the polyamide thin film was hand-cast using IP.

Briefly, the NIL process was carried out in an Eitrie 3 (Obducat, Inc.) nanoimprinter, using a silicon mold containing parallel line-and-space gratings (a periodicity of 834 nm, groove depth of 200 nm, and a line-to-space ratio of 1:1). The Si mold surface was treated with a Piranha® solution (3:1 concentrated sulfuric acid to 30% hydrogen peroxide solution) prior to the imprinting. The NIL process was carried out at 120° C. with a pressure of 4 MPa for 180 s, and the mold was separated from the membrane samples at 40° C. (FIG. 1A). The imprinted UF membranes were cleaned with and stored in deionized (DI) water in the dark until forming the polyamide layer. Non-patterned TFC membranes that served as a reference were fabricated using the same IP process on the PES UF membranes.

Both patterned and non-patterned UF membranes were taped to a glass plate with the skin layer facing upwards, and placed in an aqueous amine monomer solution (FIG. 1B). The aqueous amine solution was prepared by adding 2 g of triethylamine (TEA, 99.5%, Sigma Aldrich), and 4 g of (+)10-camphor sulfonic acid (CSA, 99.0%, Sigma Aldrich), to ˜80 mL of DI water under vigorous stirring. CSA improves the absorption of the amine solution in the support membrane, while TEA accelerates the MPD-TMC reaction. After complete dissolution of the TEA-CSA mixture, DI water was added to reach a total solution of 100 mL. Next, 2 g of 1, 3-phenylenediamine (MPD, Sigma Aldrich) were added to the TEA-CSA solution. The entire UF membrane was then immersed in the aqueous MPD-TEA-CSA solution for 8 s, and the excess solution on the membrane surfaces was removed with an air blower. Subsequently, the amine-soaked UF membrane was immersed in a hexane solution (Fisher scientific) containing 0.1% (w/v) trimesoyl chloride (TMC, 99%, Sigma-Aldrich) for 8 s. The resulting membrane was withdrawn from the hexane solution, cured at 70° C. for 10 min, and washed thoroughly with DI water. The as-prepared TFC membranes, with or without surface patterns, were stored in DI water at 5° C. in the dark.

### Example 4

### Filtration Experiments

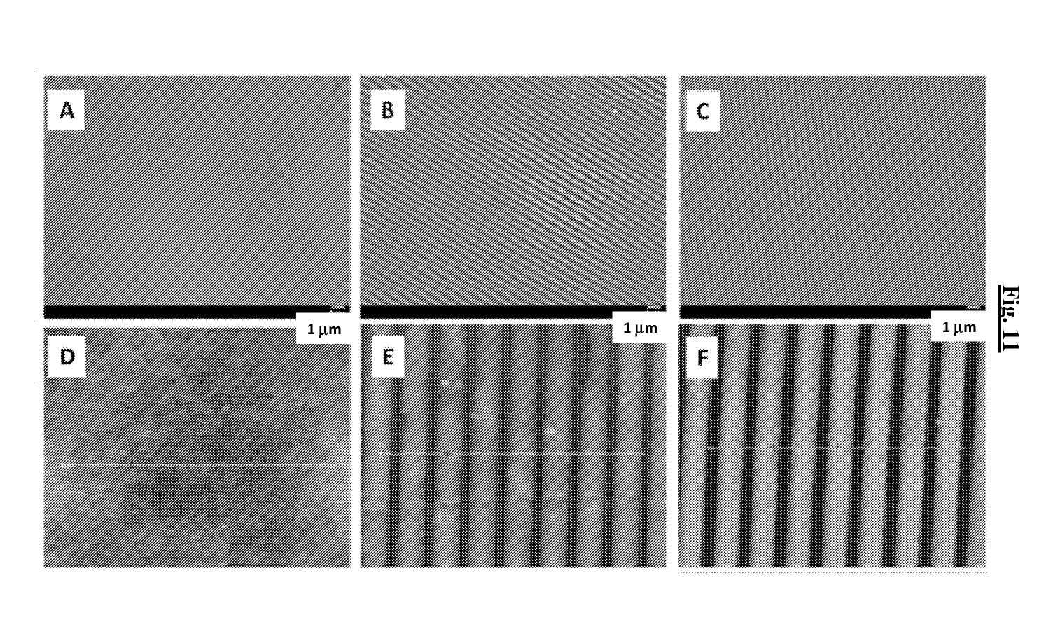

All of the filtration experiments with the TFC membranes were conducted in a Sterlitech HP4750 high-pressure stainless steel stirred cell (Sterlitech, WA) using a constant-pressure, stirred/unstirred, dead-end (normal flow) filtration configuration. The schematic of the filtration setup is provided in the supporting information (FIG. 9). The cell had an inner diameter of 3.2 cm and an effective membrane area of 8.48 cm², and used high-pressure nitrogen to supply the required pressure. The permeation mass flow-rate was obtained by weighing samples over timed intervals using an automated electronic balance (PI-225DA, Denver Instrument). All of the filtration experiments were carried out at room temperature (˜25° C.).

The entire experimental protocol utilized the following steps. For a given membrane, DI water filtration was carried out at three operating pressures, 1.38, 2.07 and 2.76 MPa, for 2 h, following a 2.5-3 h membrane compaction at each pressure. Permeate flux approached steady state after the compaction period, and compaction for the membranes (estimated by the change in membrane resistance relative to the initial, uncompacted state) typically ranged from 28% to 33%. After the completion of the pressure-stepping, DI water filtration was conducted at 2.76 MPa for 12 h. Subsequently, the pressure was released completely, and the DI water feed was replaced with a 1000 mg/L aqueous NaCl (Mallinckrodt, St. Louis, Mo.) solution. Filtration of the salt solution was carried out at a pressure of 2.76 MPa over 3 hours, and the collected permeate was weighed and the conductivity was measured every 10 minutes. The conductivity was measured with an Ultrameter 6 P (Myron L, Carlsbad, Calif.), and the concentrations were calculated from the calibration curve prepared for the instrument. For each membrane sample, NaCl filtration was performed twice for both stirred and unstirred conditions. After the NaCl filtration the pressure was released, the whole filtration system along with the membrane sample was rinsed in DI water, and the NaCl solution was replaced by a 1,000 mg/L CaCl₂ aqueous solution. Filtration of the CaCl₂ solution was carried out using the same protocol as that for the NaCl solution, at both stirred and unstirred conditions.

After the CaCl₂ filtration the pressure was again released, and the whole filtration system along with the membrane sample was cleaned using DI water. Finally, the solution was replaced by a 1,000 mg/L CaSO₄ (gypsum) solution for a scaling experiment, which was performed using an operating pressure of 2.76 MPa over 24 h under the stirred condition only. After each filtration experiment, the membrane sample was collected and rinsed with DI water to remove loosely attached gypsum crystals from the membrane surface and kept in a refrigerator at 5° C. in a sealed container for SEM inspection. SEM images of the scaled membranes were taken at different and representative regions across the membrane samples. The SEM samples were prepared by drying the scaled membranes at room temperature for 24 h and then resealing them in a Petri dish at 5° C. until the SEM imaging. Prior to SEM imaging, both patterned and non-patterned membranes were coated with ˜4 nm of gold.

### DI Water Filtration:

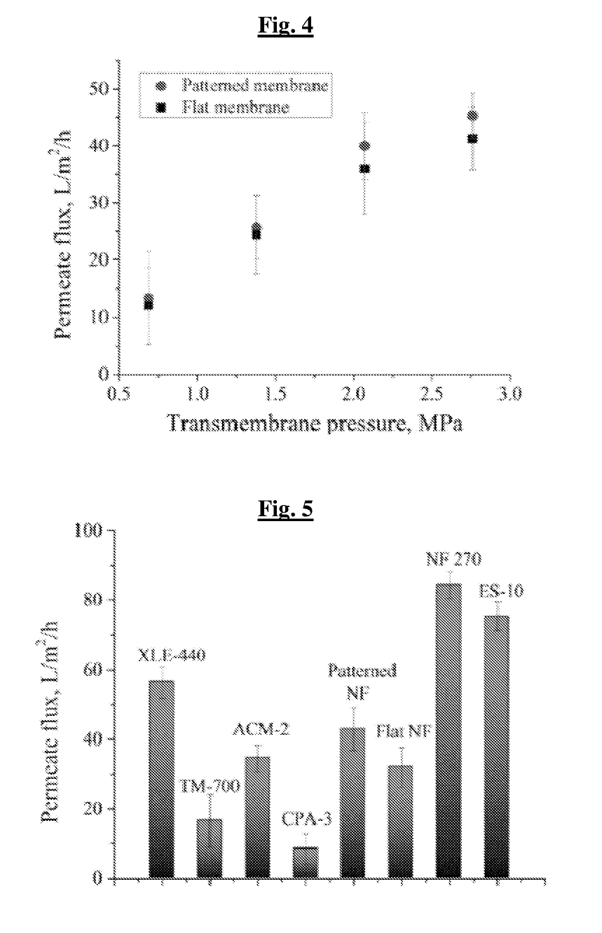

First, the DI water permeate flux of non-patterned and patterned TFC membranes was compared using the dead-end filtration setup as described in FIG. 9. This arrangement was used instead of conventional cross-flow filtration because of the limited size of current patterned UF membrane supports. As shown in FIG. 4, water flux for both membranes increased linearly with the applied pressure, which is expected for membranes during DI water filtration. At each pressure the membranes were compacted until the flux reached a steady-state value. The flux data reported in FIG. 4 are mean values over 2 h of filtration at the steady-state condition. At higher pressure, slight deviation from the linear flux-pressure relationship was observed for both membranes, which is attributed to increased membrane compaction under higher pressure. Overall, the water permeate flux for the patterned and non-patterned TFC membranes was similar, with a slightly higher flux observed for patterned membranes at higher pressures. The patterned TFC membrane may be somewhat more compaction-resistant, particularly in the relatively high pressure region, possibly because of the densification of the UF membrane support during the NIL process.

Subsequently, the permeate flux of the non-patterned and patterned membranes were determined at 2.75 MPa over 8 h of filtration and compared with that of several commercial RO and NF membranes using the same filtration conditions. The permeate fluxes after compaction are summarized in FIG. 5. The four commercial TFC RO membranes, XLE-440 (DOW Filmtec), CPA 3 (Hydranautics), ACM 2 (Trisep), and TM-700 (Toray). Although the exact chemistry of the polyamide layer likely differs for the different commercial membranes, they are all based on the MPD-TMC IP process (FIG. 1B). The two NF membranes, NF 270 (Hydranautics) and ES-10 (Nitto Denko), also have similar aromatic polyamide structures, but typically have much higher water permeate flux and lower ion rejection (particularly for monovalent ions) than the RO membranes. Salt rejection and pure water permeance for the commercial membranes are listed in Table 1.

TABLE 1
Salt rejection and pure water permeance for commercial membranes
(from manufacturer specs)

| | XLE | | | | | |
|---|---|---|---|---|---|---|
| Membranes | 440 | TM 700 | ACM 2 | CPA 3 | NF 270 | ES 10 |
| Salt rejection, | 99.7 | 99.5 | 99.7 | 99.0 | 97.0 | 95.5 |
| % (NaCl) | | | | | | |
| Water | 3.05 | 2.88 | 1.10 | 6.25 | 11.03 | 5 |
| permeability, | | | | | | |
| L/(m² · hr · bar) | | | | | | |

TFC RO membranes are used primarily for water desalination, while NF membranes are used for the removal of mineral scale, biological matter, colloidal particles and insoluble organic constituents from water feed streams. As shown in FIG. 5, both patterned and non-patterned TFC membranes showed higher pure water permeation (PWP) flux as compared to most of the RO membranes (except XLE-440) and lower flux than the two NF membranes. The water permeate flux of a TFC membrane depends on the properties of the barrier layer (chemistry, crosslinking density, thickness, roughness) as well as those of the substrate(s). The data represented in FIG. 5 confirm that the IP procedure that was employed for the non-patterned and patterned UF substrates achieved water permeate flux values that are comparable with those of typical RO and NF membranes that use similar barrier layer chemistry.

### Filtration of NaCl and CaCl₂ Solutions

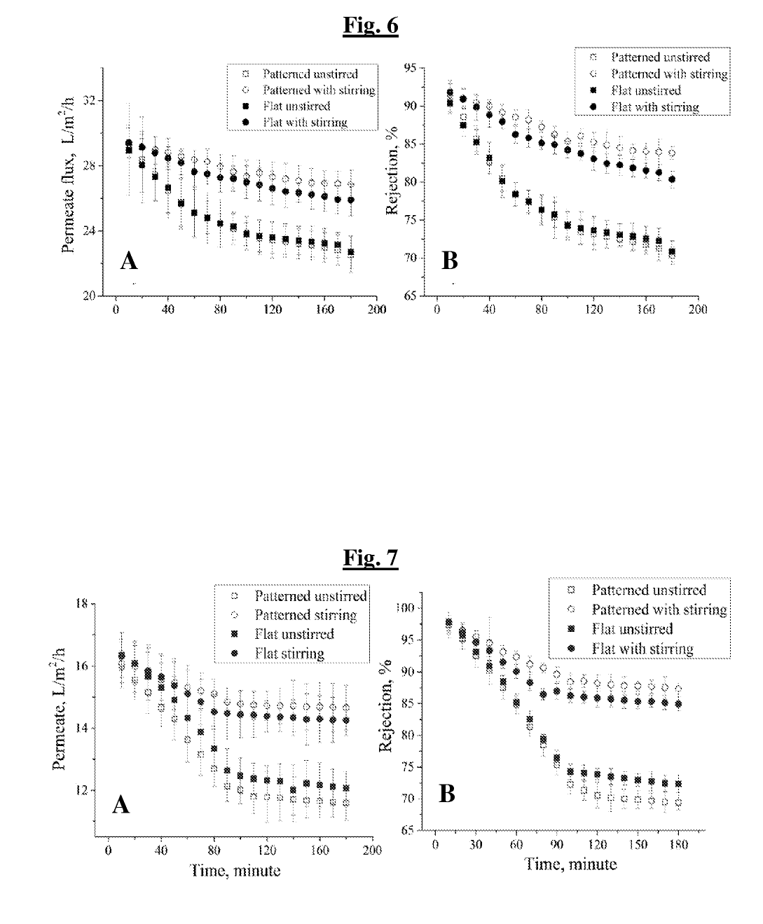

FIG. 6 presents the permeation results for both patterned and non-patterned TFC membranes during filtration over 3 h of the NaCl solution. For each membrane, permeate flux (FIG. 6A) and observed salt rejection (FIG. 6B) gradually decreased with filtration time while the intrinsic salt rejection remained essentially constant. Specifically, the initial flux for each membrane was ˜29 L m⁻² h⁻¹. For the unstirred condition the flux decreased over time by ˜21% for the non-patterned membrane and ˜22% for the patterned one. With stirring, flux reduction was ˜12% and ˜8% for the non-patterned and patterned membrane, respectively. Similar to the permeate flux, the observed salt rejection decreased ˜22% for both non-patterned and patterned membranes in the unstirred condition, and for the stirred condition ˜13% and ˜9% for the non-patterned and patterned membranes, respectively. These time-dependent reductions in permeate flux and observed solute rejection are due to both the increased feed salinity due to water removal, and the concentration polarization at the membrane-solution interface.

Initial observed salt rejection for all of the samples was ˜90% with relative variability (FIG. 6B). Initial permeate was collected after 25 min of filtration to allow the system to stabilize. The observed salt rejection, R₀, was calculated from the bulk concentration of salt in the permeate (Cₚ) and feed (C_{f}) solutions, according to R₀ (%)=(1−Cₚ/C_{f}). In any RO/NF filtration system the observed salt rejection does not represent the true membrane separation capability due to concentration polarization. Intrinsic salt rejection, Rᵢ=(1−Cₚ/Cₘ), based on the boundary layer solute concentration (Cₘ) is normally higher than R₀ because Cₘ is higher than Cf. Cₘ can be determined from a mass balance over the boundary layer according to

$${J}_{v} = \frac{{D}_{i}}{{δ}_{i}} ln [ \frac{( {C}_{i , m} - {C}_{i , p} )}{( {C}_{i , b} - {C}_{i , p} )} ] = {k}_{i} ln [ \frac{( {C}_{i , m} - {C}_{i , p} )}{( {C}_{i , b} - {C}_{i , p} )} ]$$

where Jᵥ is the total volumetric flux, D, is the diffusivity of solute i in water, δᵢ is the thickness of the boundary layer, C_{i,m} is the concentration in solution at the feed-membrane interface, C_{i,p} is the permeate concentration, C_{i,b} is the bulk concentration, and kᵢ is the mass-transfer coefficient (Murthy, et al., 1997, Desalination 109:39-49). The mass-transfer coefficient was estimated using the osmotic pressure model described by Sutzkover et al. (Sutzkover, et al., 2000, Desalination 131:117-127), which assumes no composition dependence for water permeance through the membrane. Accordingly, the Rᵢ, for the membrane samples were in the range of 98-99% over the period of the filtration time.

Since the UF support membrane had an observed rejection of ˜7% for NaCl with a permeate flux of ˜621 L m⁻² h⁻¹, the high NaCl rejection (and correspondingly lower flux, 38-24 L m⁻² h⁻¹) for both the TFC membrane types verifies the successful formation of dense and continuous polyamide barrier layers. For comparison, MPD/TMC-based TFC RO membranes have a NaCl rejection between 65% and 99%, while commercial membranes can attain over 99.5% rejection. The variability in these rejection values is caused by the barrier layer properties, operating conditions, and additional membrane modifications. In addition, polyamide-based TFC NF membranes have a reported NaCl rejection range between 60% and 80%. Thus, the TFC membranes prepared herein had a NaCl selectivity less than that of commercial RO membranes, and higher than typical NF membranes. These values are consistent with the lower DI water flux comparisons presented in FIG. 5 such that the patterned and non-patterned TFC membranes can be regarded as “tight NF” or “loose RO” membranes.

The practical water (A) and salt permeances (B) for the salt filtration were calculated using the relationships A=J_{w}/(ΔP−Δπ) and B=CₚJ_{w}/(Cₘ−Cₚ). Results, which are detailed in FIG. 10, indicated that the water permeance decreased significantly while the salt permeance remained relatively constant over the filtration period. Concentration build-up at the membrane barrier layer increases the osmotic pressure, which in turn decreases the water permeance by reducing the effective TMP. For unstirred filtration conditions concentration polarization is more severe because the boundary layer, over which diffusion returns the solute to the bulk solution, is larger. Back diffusion is enhanced by advection due to stirring (the boundary layer moves closer to the membrane surface), which leads to less concentration polarization. This explanation is consistent with the effects shown in FIG. 6.

Although the flux and salt rejections appear quite similar for the non-patterned and patterned TFC membranes for the unstirred condition, there are small but important differences when stirring was applied. Here, the flux and salt rejection for the non-patterned membranes evidenced a more pronounced decrease over the 3 h filtration period as compared to their patterned counterparts. This behavior strongly suggests that the presence of the surface patterns on the TFC membrane changes the mass transfer in the vicinity of the membrane surface, i.e., enhances back diffusion (transport) to the bulk. The presence of the surface patterns is likely to modify the flow profile and local streamlines of the feed solution in the proximity of the patterns, producing localized turbulence and/or large shear stresses. The secondary flows depend on the Reynolds number (Re) of the tangential flow over the membrane, and can be much more extensive at higher Re values.

Filtration experiments were also performed with a model divalent salt, CaCl₂, using the same protocols. Initial salt rejection for all of the samples was ˜97% with somewhat higher variability than that with NaCl. Permeate flux for CaCl₂ filtration was lower than that for NaCl due to higher osmotic pressure and greater concentration polarization from the interaction between the negatively charged TFC membrane and the divalent Ca²⁺ salt. As was the case for NaCl (FIG. 6), both permeate flux (FIG. 7A) and observed salt rejections (FIG. 7B) for all of the samples decreased from the onset of the experiment while intrinsic salt rejection remained relatively constant. Under unstirred conditions, the flux decreased by ˜26% and ˜28% for the non-patterned and the patterned TFC membranes, respectively. The salt rejection evidenced similar decreases of ˜26% for the non-patterned membranes and ˜29% for the patterned membranes. With stirring, the non-patterned and patterned membranes had flux decreases of ˜13% and ˜9% and salt rejection declines of 13% and ˜10%, respectively. Hence, results from filtration of both monovalent and divalent salt solutions are consistent and imply that the better performance of the patterned membranes is due to reduced concentration polarization arising from surface-pattern-induced hydrodynamic effects.

Scaling with CaSO₄ Solutions

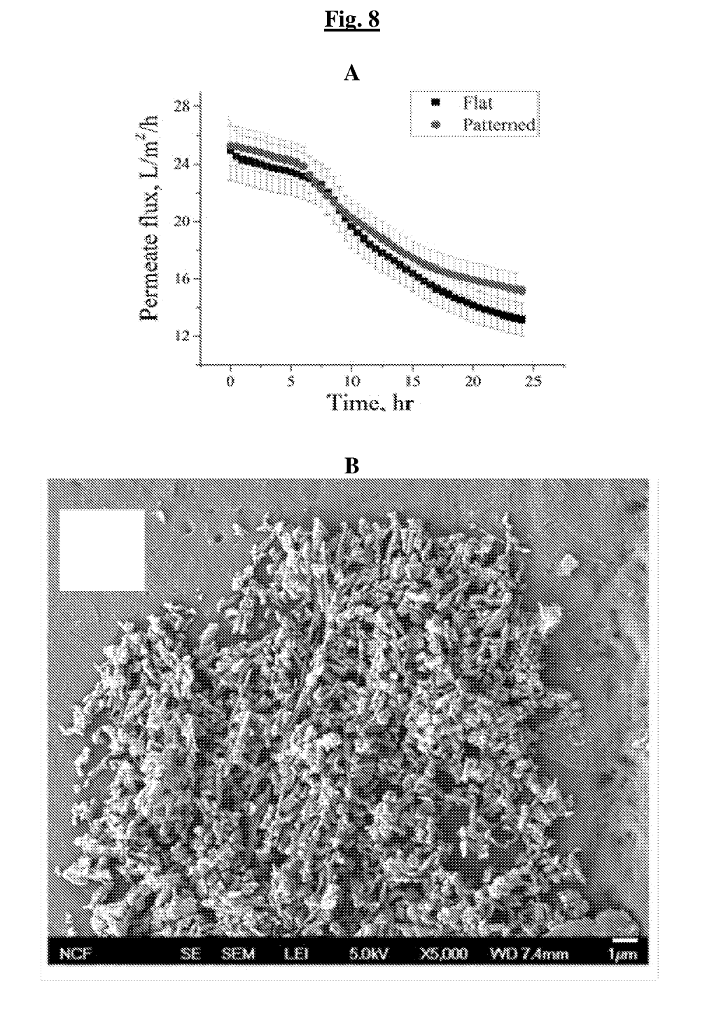

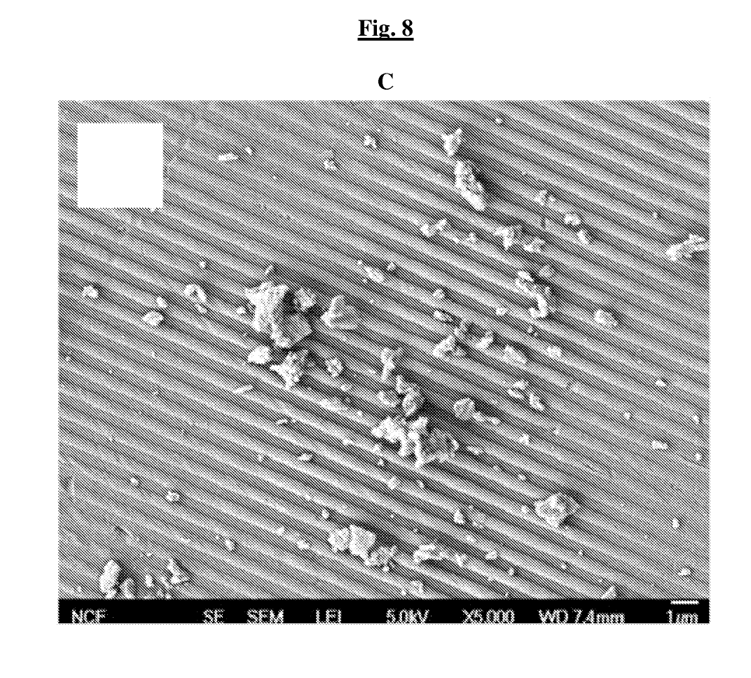

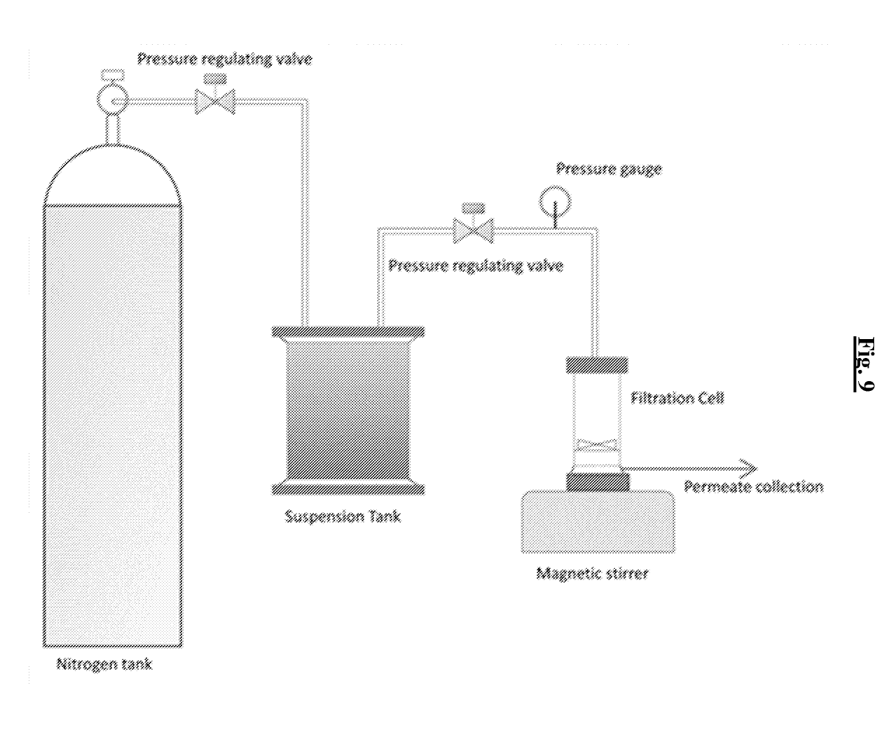

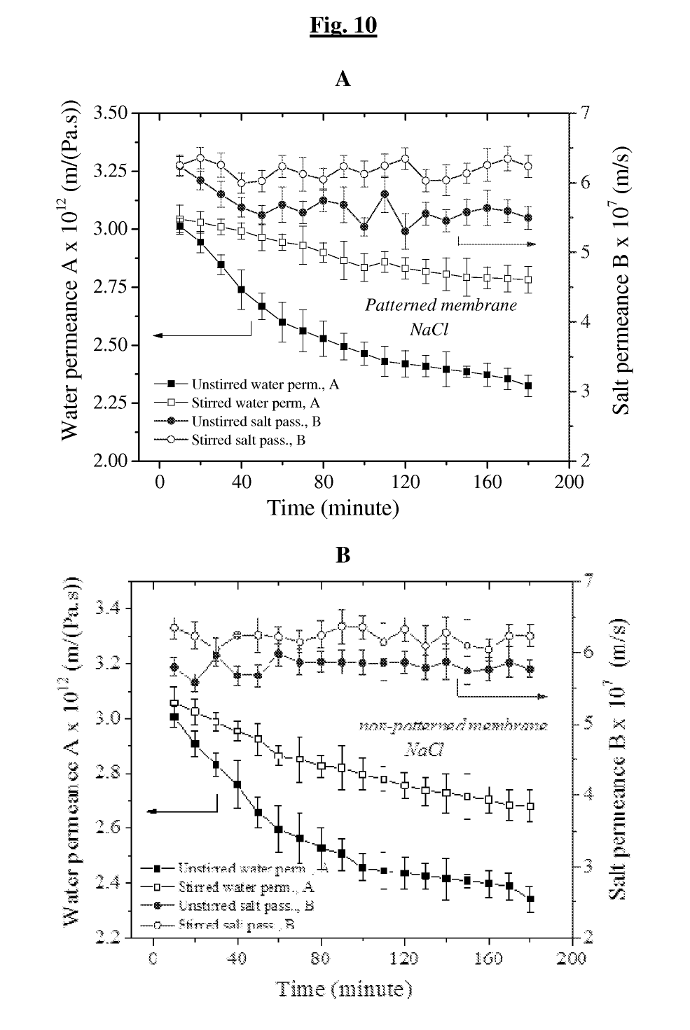

Scaling experiments with a 1 g/L CaSO₄ (gypsum) solution were performed on both non-patterned and patterned TFC membranes using dead-end filtration system but only with stirring. As shown in FIG. 8A, the initial permeate flux of both membranes was ˜25 Lm⁻² h⁻¹ and subsequently decreased in two distinct stages. After 6-7 h of filtration, the flux decreased ˜9.7% and ˜6.7% for the non-patterned and patterned TFC membranes, respectively, which is primarily due to the increasing osmotic pressure of the feed and the associated concentration polarization effect as observed in FIGS. 6 and 7. Subsequently, a steeper flux decline was observed for each membrane type whereby after 24 h the initial values of flux had declined by ˜47% and ˜40% of for the non-patterned and patterned membranes, respectively. The second stage of flux decline is attributed to the scaling of gypsum on the membrane surfaces. From FIG. 8A, it appears that the onset of scaling on the patterned TFC membrane (˜6 h) was somewhat more rapid than for the non-patterned membrane (˜7.5 h). This induction time indicates the point at which CaSO₄ reached its solubility limit in the feed solution such that precipitation on the membrane surface is initiated. Continued precipitation initiates scaling which leads to a marked decrease in the permeate flux as less surface area is accessible for the permeate. Because of the higher permeate flux of the patterned membrane during the initial stage, over-saturation of the CaSO₄ was likely reached sooner.

FIGS. 8B and 8C presents representative SEM images of gypsum on the non-patterned and patterned TFC membranes after the 24 h filtration period. Crystallization of the CaSO₄ during filtration can occur using both homogeneous nucleation in the bulk feed solution and heterogeneous nucleation on the membrane surface. The latter mechanism often produces distinctive plate-like crystal forms. The morphology of the gypsum crystals (FIGS. 8B and 8C) was bulk-like on both membranes with very few needle-like (and no clear plate-like) crystallites in FIG. 8B, which suggests that the scaling was dominated by bulk crystallization of the gypsum. Statistical analysis of the relatively constant flux values obtained over the final hour of the tests indicates that the flux for the patterned membranes is significantly higher than that for the non-patterned membranes (one-tailed t-test; p<0.05). This difference in permeate flux is consistent with the sparser distribution of gypsum crystals observed on the surface of the patterned membrane (FIGS. 8B and 8C), presumably due to the aforementioned pattern-induced hydrodynamic effects. In addition, the crystals formed during filtration with the patterned membranes were less adherent as judged by the fact that they were more easily removed during water rinsing at the completion of the experiment. Overall, the patterned membrane provided a lower cake resistance per unit mass (surface area) of deposition.

### Example 5

### Fractionation and Flux Decline Studies of Surface-Patterned Nanofiltration Membranes

As described herein, longer-duration permeation studies of aqueous sodium chloride (NaCl) and glycerol with bovine serum albumin (BSA) protein, as a surrogate for the range of colloidal foulants that are often present in various feed waters, were assessed. Permeation tests were performed in a crossflow filtration cell, allowing for better characterization of the boundary layer compared to a stirred cell. In certain embodiments, the angle-of-attack between the bulk flow and the patterns were controlled. The glycerol/NaCl/water fractionation properties are evaluated using the solution-diffusion model, and the fouling properties are evaluated based on permeance decline, permeance recovery, and post-mortem characterization. In addition, the variability in transport metrics within a single batch and between batches of these laboratory-scale membranes were assessed.

### Materials and Methods

### Membrane Fabrication:

The substrate was a commercial polyethersulfone (PES) UF membrane (PW, GE Water and Infrastructure) with a nominal 30 kg/mol molecular mass cutoff. The nanoimprinting process used for the UF membrane in this study is described in Maruf, et al., 2013, J. Membr. Sci. 428:598-607. Briefly, the NIL process was carried out in an Eitrie 3 (Obducat, Inc.) nanoimprinter using a silicon mold containing parallel line-and-space gratings (a periodicity of 575 nm, a line width of 210 nm and a groove depth of 180 nm). The Si mold surface was treated with a Nanostrip® solution prior to the imprinting. The NIL process was carried out at 120° C. and 4 MPa for 180 s, and the mold was separated from the membrane samples at 40° C. The imprinted UF membranes were then cleaned and stored in deionized (DI) water in the dark prior to the interfacial polymerization (IP) step.

The first step of the IP process was to tape either the flat or imprinted UF substrate to a glass plate, with the skin layer facing out. Next, the substrate was immersed in an aqueous amine solution. This solution was prepared by adding 2 g of triethylamine (TEA, 99.5%, Sigma Aldrich) and 4 g of (+)10-camphor sulfonic acid (CSA, 99.0%, Sigma Aldrich) to about 80 mL DI water with vigorous stirring. After the TEA-CSA mixture was completely dissolved, DI water was added to reach a total volume of 100 mL. Next, 2 g of 1,3-phenylenediamine (MPD, Sigma Aldrich) was added to the TEA-CSA solution. The entire UF membrane was then immersed in the aqueous MPD-TEA-CSA solution for 8 s, and the excess solution on the membrane surface was removed with an air blower. Subsequently, the amine-soaked UF membrane was immersed in a hexane solution (Fisher Scientific) containing 0.1% (w/v) trimesoyl chloride (TMC, 99%, Sigma-Aldrich) for 8 s. The membrane was then removed from the hexane solution, cured at 70° C. for 10 min, and rinsed thoroughly with DI water. Finally, the as-prepared flat-NF and NIL-NF membranes were stored in DI water at 5° C. in the dark for 1-3 weeks.

### Membrane Characterization:

The surface topographies of the membranes, before and after fabrication processes, were examined with a field-emission scanning electron microscope (FESEM, Zeiss, Supra 60) and an atomic force microscope (AFM, Dimension 3100 AFM, Bruker). Membrane samples were dried in a vacuum oven and coated with a ˜4 nm gold layer prior to FESEM measurements. All AFM measurements were performed in tapping mode under ambient conditions using silicon cantilever probe tips (Veeco, RTESP) with spring constants ranging between 20 and 80 N/m (nominal manufacturer specifications).

### Membrane Filtration:

Each set of membranes was tested in triplicate. Experiments were conducted using the same 3-cell membrane apparatus, experimental methods, and analytical protocols described previously (Rickman, et al., 2013, Ind. & Eng. Chem. Res. 52:10530-10539). Briefly, three membranes, each with a surface area of 9.6 cm², were placed in this membrane module. A pump (Hydra-Cell, D/G-03 Series) was used to pressurize the solution from a single, 4 L feed, which was split into three streams upstream of the module, such that the three replicates were obtained simultaneously from the same feed solution in parallel. The imprinted membranes were installed such that the pattern grooves were perpendicular to the crossflow.

Membranes were conditioned with DI water at 25° C. at a transmembrane pressure of either 12 or 24 bar. Crossflow was provided at a rate of 0.26 m/s (Re ˜10³). Permeance was measured using a balance and timer, and is reported herein as the permeate flux per unit transmembrane pressure (L/m²/h/MPa, or LMH/MPa). Membrane conditioning was continued for up to 13 days until the pure water permeance (PWP) decreased less than 3% over the previous 24-h period. Next, the feed was replaced with a solution of 0.14 M NaCl and 0.014 M glycerol in water, and the pressure was again increased to its initial value. The solution permeance was measured for 5 h to ensure its stability, and then samples were taken from the feed and permeate for later analysis. Next, a model protein foulant, BSA, was added to the feed at a concentration of 0.1 g/L, and the solution permeance was periodically measured. Samples were again taken from the feed and permeate after 2 h.

The permeance decline during BSA filtration was measured for 2 h for the membranes tested at 12 bar, and for 26 h for the membranes tested at 24 bar. Finally, the pressure regulators were opened, the system was flushed three times with 4 L DI water (12 L total) at the same crossflow velocity as used in the filtration studies, the pressure regulators were reset to the initial pressure, and then the final pure water permeance was measured.

Samples were later analyzed for their glycerol and NaCl concentrations using high-pressure liquid chromatography (HPLC) with a refractive index detector (Agilent 1100 Series). The 50-μL samples were injected into a hydrogen column (Phenomenex Rezex RHA), which was maintained at 60° C. The mobile phase was degassed DI water with a flow rate of 0.6 mL/min. Concentrations were calculated using calibration curves, ensuring that measurements were taken within the linear response range between concentration and refractive index.

Transport was modeled using the solution-diffusion model (Wijmans, 1995, J. Membr. Sci. 107:1-21). Corrections for the concentration polarization boundary layer were made using a Sherwood correlation for laminar flow in a horizontal slit (Cussler, Diffusion: Mass Transfer in Fluid Systems, 2^{nd} Ed., Cambridge University Press, New York, 1997), consistent with the geometry of the membrane module (Rickman, et al., 2013, Ind. & Eng. Chem. Res. 52:10530-10539). The primary transport metric used herein is the separation factor, α_{i/j}, and is calculated as the ratio between solution-diffusion permeance coefficients, P, for penetrants i and j, i.e., α_{i/j}=Pᵢ/Pⱼ. The penetrants include water (w), NaCl (electrolyte, e), and the glycerol (reduced carbon, r). If α_{i/j}<1, then penetrant i is less permeable than penetrant j, given the same activity driving force; if α_{i/j}>1, then the converse is true. The filtration protocol is summarized in Table.

TABLE 2
Summary of the filtration protocol that was performed for three
NIL-NF and three flat-NF membranes at 12 bar and 24 bar.

| Feed composition | Transport metrics |
|---|---|
| DI water | Initial PWP until compaction criterion met |
| | (<3% change per day) |
| 0.14M NaCl, 0.014M | Solution-diffusion permeance coefficients |
| glycerol, water | (Pᵢ), overall solution permeance (LMH/MPa) |
| 1 g/L BSA, 0.14M NaCl, | Solution-diffusion permeance coefficients |
| 0.014M glycerol, water | (Pᵢ), overall solution permeance (LMH/MPa) |
| DI water | Final PWP |

### Post-Mortem Biochemical Assay and Gravimetric Measurements:

A post-mortem biochemical assay was used to characterize the protein associated with the membrane after permeation experiments (Kujundzic, et al., 2010, J. Membr. Sci. 349:44-55). After removing the membranes from the test cell, the membrane sample was sectioned into a ˜7 cm² coupon. Next, the mass of each membrane coupon was measured using a high-resolution microbalance (Model ME235S, Sartorius). Water-soluble proteins were then eluted from the membrane coupons and their concentration measured using the following procedure: (1) the membrane coupon was aseptically placed in a 50 mL clean plastic test tube; (2) 15 mL of ultrapure sterile water was added, and the resulting solution was sonicated on ice for 1 h; (3) the eluent was analyzed for protein content using a bicinchoninic acid kit and a BSA standard calibrator (Pierce); and (4) a spectrophotometer (model DR/2010, Hach) was used to measure the sample's absorbance at a wavelength of 562 nm. The lower detection limit of this protein assay under the conditions used was about 12 μg/cm². The mass of the membrane coupon was again measured, and the percent increase in mass of the protein-fouled membranes compared to the sonicated membranes was calculated. Finally, the sonication protocol was repeated a second time to determine whether most of the protein on the membrane surface that could easily be removed using sonication was removed during the first iteration of the sonication protocol.

The experimental results are now illustrated.

### Membrane Characterization:

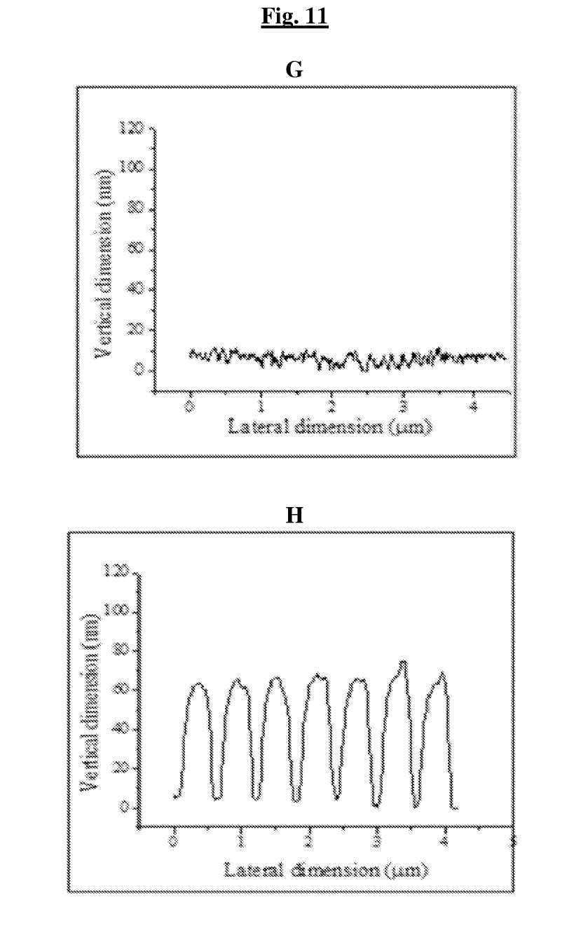

AFM profiles and FESEM images of the flat-NF, NIL-UF, and NIL-NF surfaces are illustrated in FIG. 11. The flat-NF membranes had random surface roughness with heights on the order of 10 nm. The imprinted UF substrate had a regular, patterned surface with a ˜60 nm groove depth, while the groove depth of the polyamide thin-film, which was fabricated on top of the patterned UF substrate, had a reduced groove depth of ˜30 nm. Without wishing to be limited by any theory, the interfacial polymerization filled in some of the surface pattern of the UF membrane, but still results in a regularly patterned surface with larger protrusions as compared to the random roughness on the flat-NF membrane.

### Membrane Filtration Experiments:

Initial Membrane Conditioning:

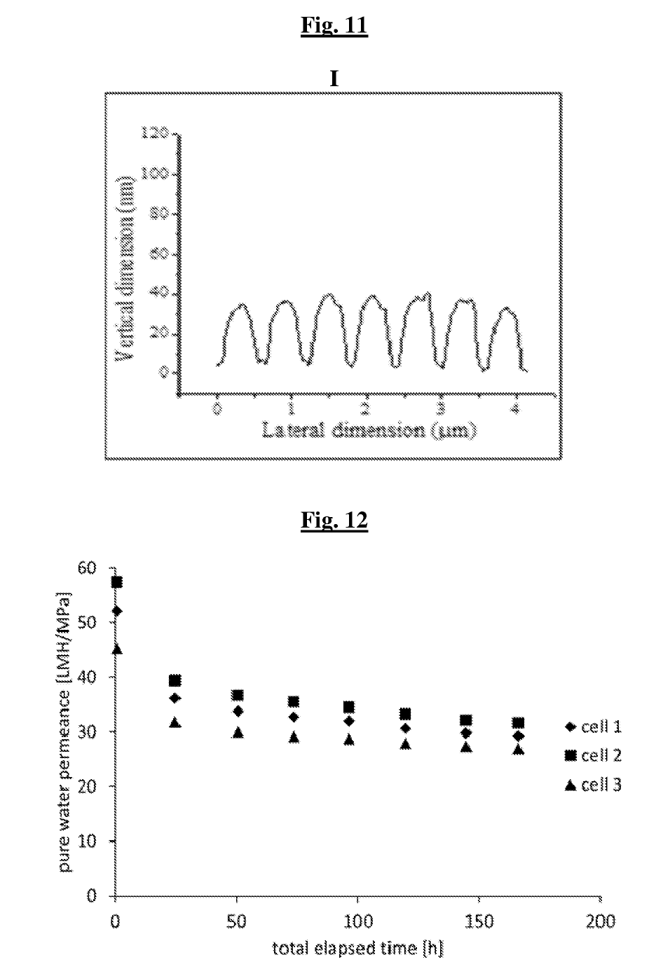

Prior to filtering solutions, all membranes were first conditioned with DI water at a transmembrane pressure of either 12 bar or 24 bar. FIG. 12 illustrates an example of the permeance measured for each of three NIL-NF membrane replicates during the initial conditioning period at 24 bar. During this time, the pure water permeance (PWP) of all membranes decreases, likely due to substrate deformation (compaction). The differences among the replicates were rather large, which may be explained at least in part by the fact that non-automated, manual techniques were employed to fabricate the membranes. Despite their different initial permeances, each membrane displayed similar trends in permeance decline during compaction.

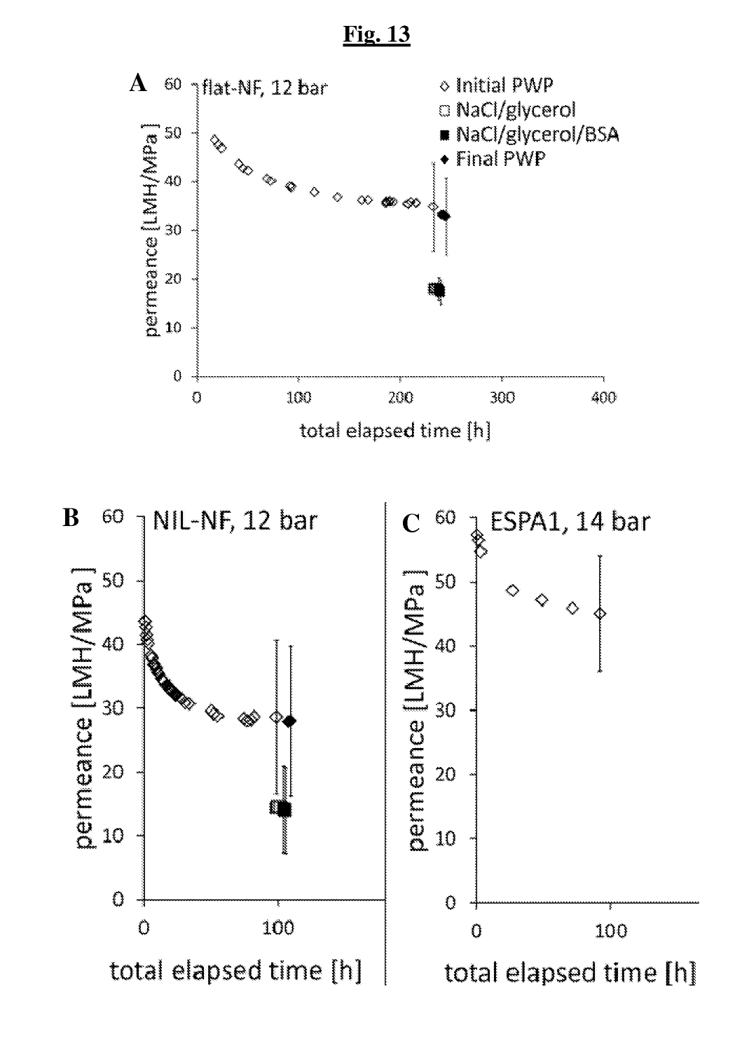

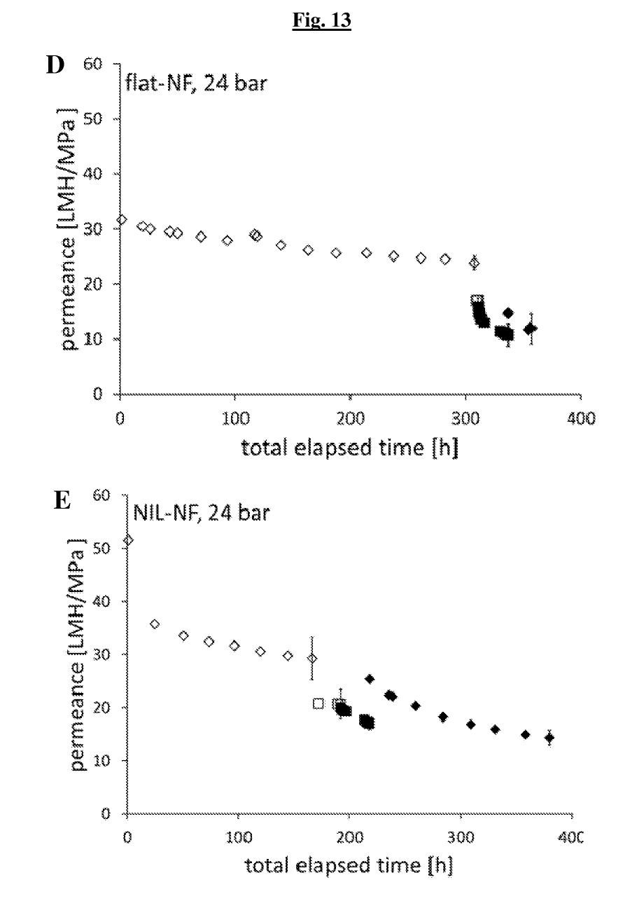

FIG. 13 illustrates the mean values from the triplicate measurements, and 90% confidence intervals are included only for the final datum from each series. During this time, the PWP of all membranes decreased, likely due to compaction (open diamond symbols in FIG. 13). Although the NIL-NF membrane permeance at 12 bar stabilizes after about 3 days, the permeance of the NIL-NF at higher pressure and that of the flat-NF at both pressures continued to decrease monotonically over longer times. This behavior of prolonged permeance decrease is also consistent with that of a commercial PA membrane (ESPA1, Hydranautics, FIG. 13C).

To accommodate the polymer deformation that occurs over long time scales, a criterion was set, wherein in certain embodiments for a membrane to be considered “stable” there had to less than 3% decrease in PWP over the previous 24 h period. Without wishing to be limited by any theory, in certain embodiments the NIL-NF membrane stabilizes more quickly than the flat-NF membrane at 12 bar because the substrate has essentially been pre-compacted during the nanoimprinting process, which applies a pressure of 4.0 MPa (40 bar) to the patterning mold/membrane at an elevated temperature (120° C.).

In general, increased PWP conditioning time and pressure reduces the differences among replicates (for example, see the confidence intervals in FIG. 3A vs FIG. 3D, and FIG. 3B vs FIG. 3E). Without wishing to be limited by any theory, this finding may eb explained at least in part by reduced variability in the substrate structure, as the largest macropores collapse and the substrate becomes more compact. The flat-NF membranes in FIG. 3D are the same as those in FIG. 3A. The flat-NF membranes were initially tested at the lower pressure; since the membrane permeance did not change significantly during the low-pressure experiment, the membranes were used again for the high-pressure experiment. Subsequent conditioning at the higher pressure further reduced the permeance of these flat-NF membranes, indicating that the substrate deforms more when it is subjected to a greater mechanical force. The permeance of the flat-NF membranes at 24 bar increased 2-5% at about 115 h. This increase corresponded to a power outage that turned off the pump, and hence reduced the pressure, and suggests that the substrate deformation that occurred during membrane conditioning was at least partially recoverable. In certain embodiments, the reported PWP for a polymer membrane can be highly sensitive to its history. In other embodiments, baseline measurements for the rate of change in membrane permeance may be necessary when interpreting subsequent fouling behavior.

Fractionation Properties During Filtration of Aqueous NaCl/Glycerol, with and without BSA:

After the pure water permeance stabilized, the membranes' fractionation properties were measured for solutions containing water, NaCl, and glycerol, with and without BSA. The NaCl and glycerol true rejections (i.e., using the calculated concentration in the liquid at the feed-membrane interface, rather than the bulk concentration) for each membrane/pressure combination are illustrated in Table 3. Due to the high glycerol and NaCl retention, in certain embodiments, BSA was assumed to be mostly retained (because BSA has a molecular mass of 66,463 g/mol and glycerol has a molecular mass of 92 g/mol). A one-way analysis of variance (ANOVA) revealed that none of the species' permeance coefficients varied significantly (p=0.34, 0.16, and 0.52 for glycerol, NaCl, and water, respectively; a p-value of 0.34 indicates that there is only a 66% probability that the different mean values for a species' permeance with and without BSA in the mixture arise from different normal distributions; a maximum value of p=0.05 or 0.1 is usually used to test for statistical significance) or solutions with BSA versus those without it. Thus, the results indicate that only minimal further mixture non-idealities were introduced by the addition of the BSA.

TABLE 3
NaCl and glycerol rejections for flat-NF and NIL-NF membranes,
with and without BSA, at 12 bar and 24 bar. The ± values are
90% confidence intervals for three membrane replicates.

| | |
|---|---|
| R_{NaCl} [%] | R_{glycerol} [%] |

| | | no BSA | + BSA | no BSA | + BSA |
|---|---|---|---|---|---|
| 12 bar | flat-NF | 86 ± 8 | 87 ± 7 | 88 ± 4 | 89 ± 3 |
| | NIL-NF | 90 ± 4 | 90 ± 4 | 92 ± 5 | 94 ± 4 |
| 24 bar | flat-NF | 95 ± 2 | 95 ± 1 | 95 ± 1 | 96 ± 2 |
| | NIL-NF | 95 ± 1 | 96 ± 1 | 95 ± 2 | 96 ± 2 |

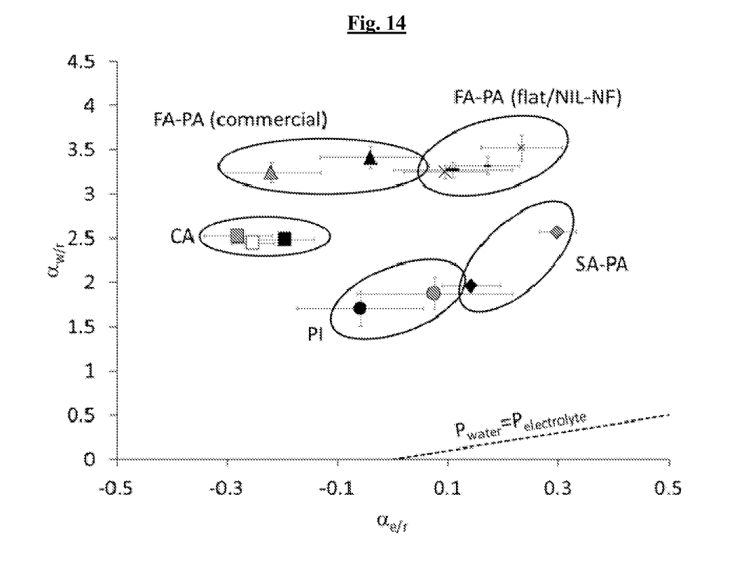

FIG. 14 illustrates the separation factors between water, glycerol, and NaCl for the NIL-NF and flat-NF membranes, together with other classes of polymer membranes. Within experimental uncertainties, imprinting the substrate did not substantially change the separation properties of the composite material. The variability within a batch of the flat-NF and NIL-NF membranes was similar to that from a section of a roll of commercially available FA-PA membrane (ESPA 1). The flat-NF and NIL-NF membranes fell within a similar but distinct region compared to commercial FA-PA membranes. Specifically, the water/glycerol separation factors were similar for both sets of membranes, but the membranes of the invention were more permeable to NaCl vs glycerol, whereas the converse was true for the commercial membranes. Polymeric structural and chemical differences between the TFCs of the invention and the tested commercial membranes provide a likely rationale for this α_{e/r} difference. The variability between batches of the NIL-NF membranes was on the order of the variability within any given batch of membranes.

Permeance Decline During BSA Filtration:

After the permeance was measured for several hours to ensure its stability, a model protein foulant, BSA, was added to the feed with continued monitoring of the permeance for evidence of possible flux decline. Comparing the open versus filled squares for FIG. 13A (flat-NF) versus FIG. 13Bb (NIL-NF), no major difference was observed when the flux was lower due to the Δp_{TM}=12 bar. Under these circumstances, there did not appear to be any fouling from addition of BSA. On the contrary, at the higher flux of Δp_{TM}=24 bar, comparison of FIG. 3D (flat-NF) and FIG. 3E (NIL-NF) indicated that the rate of fouling was lower for the NIL-NF, supporting the hypothesis of increased back mass transfer.

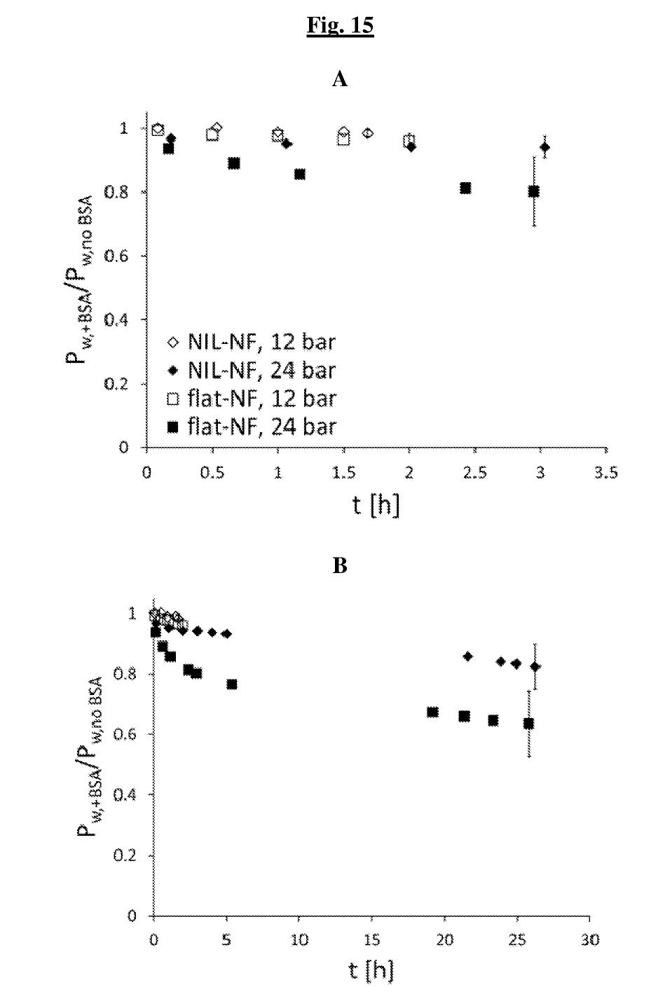

Due to the variability between the permeance of membranes in a single batch, the water permeance coefficient after BSA addition was normalized to the water permeance coefficient for the solution, prior to BSA addition. After 2 h, the permeance of all membranes tested at the lower pressure reduced minimally, to 95-97% of its value before BSA addition for the flat-NF membranes, and 97-98% for the NIL-NF membranes (FIG. 15). This low permeance decline was likely due to operation below the critical flux for BSA. A value of Jᵥ/kᵢ<1 (where Jᵥ is the volumetric flux and kᵢ is the solute's mass transfer coefficient) indicates that the flux is sub-critical, i.e., the rate of mass transfer of the solute back to the bulk is greater than (or equal to) its rate of convection toward the membrane, and deposition on the membrane is not expected. For the experiments at 12 bar, operation was likely near the critical flux for BSA deposition, such that the slight decrease in water permeance was primarily from BSA adsorption. Osmotic composition effects were already included in the activity coefficients used to calculate the permeances. Without wishing to be limited by any theory, the slightly greater permeance reduction for the flat-NF membranes may be due to the higher initial permeance of that batch of membranes, leading to a higher value of Jᵥ/kᵢ. In other words, any possible effects of the distinct architectures are confounded with their different initial permeances.

TABLE 4
Volumetric flux divided by the calculated mass-transfer coefficient
(Jᵥ/kᵢ) for NaCl, glycerol, and BSA in flat-NF and NIL-NF
membranes at 12 bar and 24 bar. The ± values are 90%
confidence intervals for three membrane replicates.

| | | | |
|---|---|---|---|
| Jᵥ/kᵢ | NaCl | glycerol | BSA |

| | | | | |
|---|---|---|---|---|
| 12 bar | flat-NF | 0.2 ± 0.0 | 0.2 ± 0.0 | 1.3 ± 0.2 |
| | NIL-NF | 0.1 ± 0.1 | 0.2 ± 0.1 | 1.1 ± 0.5 |
| 24 bar | flat-NF | 0.3 ± 0.0 | 0.4 ± 0.0 | 2.4 ± 0.1 |
| | NIL-NF | 0.3 ± 0.0 | 0.5 ± 0.1 | 2.9 ± 0.4 |

At the higher pressure, a greater initial decline in the normalized water permeance was observed for both membranes (FIG. 15). However, despite the higher initial permeance of the NIL-NF membranes, and thus higher Jᵥ/kᵢ, the decrease in permeance was significantly less for the NIL-NF than for the flat-NF membranes (p=0.018 for a paired t-test at the final point). The flat-NF membranes experienced a rapid drop in permeance over the first few hours of operation, which then stabilized to a more modest rate of permeance decline, similar to that of the NIL-NF membranes. This initial decrease in permeance was likely associated with BSA deposition. As BSA was deposited, the permeance decreases until the flux was again sub-critical and adsorption (and possibly compaction of the fouling layer) dominated. The greater permeance decline for the flat-NF membranes suggests that the NIL-NF membranes have improved hydrodynamics at the membrane-liquid interface, providing better disruption of the boundary layer and allowing for a higher critical flux. Permeance decline was still extant for the NIL-NF membranes under these conditions, but there was a significant delay in its onset, such that P_{w+BSA}/P_{w,no BSA}=0.82 was reached in ˜2.5 h for the flat-NF membranes versus 26 h for the NIL-NF membranes, despite the higher initial solution permeance for the latter (FIG. 13).

Permeance Recovery after Filtration:

After each permeation experiment with BSA solutions, the system was flushed with DI water (in simple crossflow with no extra applied pressure), and then the permeances of pure water were again measured (“Final PWP” in FIG. 13). Table 5 summarizes the percentage of the initial PWP that was recovered after filtration, relative to the fouled membrane, defined as:

$$permeance recovery = \frac{( {PWP}_{cleaned} - {PWP}_{fouled} )}{( {PWP}_{initial} - {PWP}_{fouled} )} \times 100 \%$$

The flat-NF and NIL-NF membranes that were operated at the lower pressure and experienced little permeance decline recovered much of their initial permeance. The permeance recovery was slightly higher for the NIL-NF membrane, but these membranes were also slightly less permeable than the flat-NF, and so they may have experienced less of the already low BSA deposition. The estimated Jᵥ/k_{BSA} of the flat-NF was 1.3 versus 1.1 for the NIL-NF at the 12 bar condition (Table 4).

TABLE 5
Summary of permeance recoveries after BSA filtration and post-mortem
characterizations. The ± values are 90% confidence intervals for
three membrane replicates. The mass change compares the mass of the
fouled membrane to the mass of the same membrane after sonication;
the protein concentration is measured in the sonication supernatant.

| | | permeance | mass change | protein concentration |
|---|---|---|---|---|
| | | recovery [%] | [%] | [μg/cm²] |
| 12 bar | flat-NF | 89 ± 2 | n/a | n/a |
| | NIL-NF | 96 ± 1 | 0.1 ± 0.1 | 98 ± 2 |
| 24 bar | flat-NF | 30 ± 8 | 0.7 ± 0.6 | 111 ± 1 |
| | NIL-NF | 69 ± 9 | 0.3 ± 0.1 | 104 ± 10 |

The membranes operated at 24 bar recovered much less of their initial permeance. Nonetheless, the NIL-NF membranes have about twice the permeance recovery compared to the flat-NF membranes, consistent with their improved permeance during BSA filtration (permeance recovery % is based on the PWP measured within 1 h of beginning the “final PWP”). After continuing the pure water permeation experiments for 17 h, there were about 20% and 12% drops in permeance for the flat-NF and NIL-NF membranes, respectively. The PWP of the NIL-NF membranes was measured for 7 days. During this time, the permeance declined rapidly before reaching a more stable value of 4% decrease per day. The drop in permeance took place at a much faster rate than it would be expected if it was simply caused by compaction of the membrane itself (the permeance decline criterion of <3%/day was already been set before starting the mixture filtration protocol).

Without wishing to be limited by any theory, the long-term decline in the permeance of fouled NIL-NF membranes at 24 bar appears to be caused by compaction of the deposited protein layer. The post-mortem protein analysis (Table 5) confirmed that BSA was present on the membranes after the final PWP. This protein was likely adsorbed to the membrane surface, such that it was not washed away during the post-filtration flushing or PWP. The protein concentration represented only the protein that was removed by the sonication protocol.

After the first sonication, this protocol was repeated, and the amount of protein that could be removed during the second sonication was 16 μg/cm² for each set of membranes. For reference, this value is only slightly higher than the lower detection limit of the bioassay under the conditions used (12 μg/cm²). Thus, the results indicate that most of the protein that could be easily removed using sonication was removed in the first hour of sonication.

The post-mortem analysis in Table 4 shows that the membranes with reduced permeance recovery also had more material removed during sonication and a higher protein concentration in the sonication supernatant. This protein concentration only represents the adsorbed protein that could not be removed by the shear from crossflow in the membrane module, yet could be removed by the sonication protocol. These results are consistent with the model wherein a compact protein layer is present on the surface of the membrane. Furthermore, these results suggest that the protein layer on the NIL-NF membranes has a more open structure than that on the flat-NF membrane, such that the former was more easily removed by simple crossflow while the latter requires more vigorous methods (i.e., sonication) for protein removal.

As demonstrated herein, above the critical flux, the imprinted membranes of the invention have less permeance decline and greater permeance recovery with simple flushing compared to their flat counterparts. At the higher pressure and at the conditions investigated, the NIL-NF membranes can operate for ten times longer than the flat-NF membranes before their permeance declines to 82% of the initial value. In certain embodiments, imprinted materials can be operated for longer duration between cleanings. After 26 h of BSA filtration, the NIL-NF membranes recovered 25% more of their initial permeance compared to the flat-NF membranes. Without wishing to be limited by any theory, the present results suggest that, although protein accumulates on both flat and imprinted NF membranes, its rate of deposition may be slowed on the NIL-NF membrane due to improved local hydrodynamics caused by the regular surface patterning. These features and the local shear environment may also result in a less dense protein layer, which is easier to remove with the shear provided during crossflow filtration compared to the protein layer on the flat surface.

As demonstrated herein, the imprinted membranes of the invention offer a means to increase operating time between cleanings and possibly also increase membrane lifetime without compromising the transport properties of the material, when using thin-film polymerization techniques that are already broadly utilized.

The disclosures of each and every patent, patent application, and publication cited herein are hereby incorporated herein by reference in their entirety.

While the invention has been disclosed with reference to specific embodiments, it is apparent that other embodiments and variations of this invention may be devised by others skilled in the art without departing from the true spirit and scope of the invention. The appended claims are intended to be construed to include all such embodiments and equivalent variations.

1. A thin film membrane, wherein the membrane comprises a first surface and a second surface counterfacing the first surface;
wherein a repeating pattern covers a portion of a working area of the membrane;
wherein the periodicity of the repeating pattern is equal to or lower than about 1 micrometer in size; and,
wherein the repeating pattern covers a portion of at least one selected from the group consisting of the first surface and the second surface of the membrane.

2. The membrane of claim 1, wherein the repeating pattern covers between about 20% and about 100% of the working area of the membrane.

3. The membrane of claim 1, wherein the membrane comprises at least one material selected from the group consisting of cellulose acetate, polysulfone, polyethersulfone, ionic liquid, self-assembled monolayer, rubbery polymer, polyamide, polyaramid, polyester, polycarbonate, polycarbamate, polyimine, polyurea, polyalcohol, polyether, polyphosphine, and any derivatives thereof.

4. The membrane of claim 1, further comprising at least one material selected from the group consisting of dispersed nanoparticle, metal organic framework, graphene flake, graphene oxide flake, metal oxide, carbon particle, silver, and zeolitic imidazolate framework.

5. (canceled)

6. The membrane of claim 1, wherein the pattern comprises raised or depressed portions that form shapes that include one or more of ridges, valleys, channels, hills, posts, peaks, needles, pins, knobs, parallel lines, intersecting lines and concentric lines on the membrane.

7. The membrane of claim 1, wherein the pattern comprises raised portions (projections) arranged on the membrane with a periodicity of the projections being between 10 and 1,000 nm.

8. The membrane of claim 7, wherein the pattern comprises a periodicity in a range from about 200 nm to 1,000 nm; groove depth in a range from 5 nm to 300 nm; and a line-to-space ratio in a range from about 1:1 to 1:5.

9. A thin film composite membrane comprising:
a base membrane;
a thin film membrane on a given surface of the base membrane; and,
a repeating pattern covering both the thin film membrane and the given surface of the base membrane,
wherein the periodicity of the repeating pattern is equal to or lower than about 1 micrometer in size.

10. The composite membrane of claim 9, wherein the base membrane comprises at least one material selected from the group consisting of nylon, mixed cellulose esters, regenerated cellulose, cellulose acetate, polycarbonate, polytetrafluoroethylenes, polypropylene, polystyrene, polyvinylchloride, polysulfone, poly (ether sulfone), and polyethylene.

11. The composite membrane of claim 9, wherein the thin film membrane comprises at least one material selected from the group consisting of cellulose acetate, polysulfone, polyethersulfone, ionic liquid, self-assembled monolayer, rubbery polymer, polyamide, polyaramid, polyester, polycarbonate, polycarbamate, polyimine, polyurea, polyalcohol, polyether, polyphosphine, and any derivatives thereof.

12. (canceled)

13. The composite membrane of claim 9, wherein the thin film membrane is formed using interfacial polymerization.

14. The composite membrane of claim 9, wherein the pattern comprises raised or depressed portions that form shapes that include one or more of ridges, valleys, channels, hills, posts, peaks, needles, pins, knobs, parallel lines, intersecting lines and concentric lines on the membrane.

15. The composite membrane of claim 9, wherein the pattern comprises raised portions (projections) arranged on the membrane with a periodicity of the projections being between 10 and 1,000 nm when measured at their widest point.

16. The composite membrane of claim 9, wherein the pattern comprises a periodicity in a range from about 200 nm to 1,000 nm; groove depth in a range from about 5 nm to 300 nm; and a line-to-space ratio in a range from about 1:1 to 1:5.

17. A method of preparing a thin film composite membrane, the method comprising preparing a thin film membrane on a portion of a given surface of a base membrane, wherein the portion of the given surface of the base membrane is nanoimprinted with a repeating pattern.

18. The method of claim 17, wherein the thin film membrane is prepared using a method comprising interfacial polymerization.

19. The method of claim 17, wherein the base membrane comprises a material selected from the group consisting of nylon, mixed cellulose esters, regenerated cellulose, cellulose acetate, polycarbonate, polytetrafluoroethylenes, polypropylene, polystyrene, polyvinylchloride, polysulfone, poly (ether sulfone), and polyethylene.

20. The method of claim 17, wherein the thin film membrane comprises at least one material selected from the group consisting of cellulose acetate, polysulfone, polyethersulfone, ionic liquid, self-assembled monolayer, rubbery polymer, polyamide, polyaramid, polyester, polycarbonate, polycarbamate, polyimine, polyurea, polyalcohol, polyether, polyphosphine, and any derivatives thereof.

21. The method of claim 17, wherein the pattern comprises a periodicity in a range from about 200 nm to 1,000 nm; groove depth in a range from about 5 nm to 300 nm; and a line-to-space ratio in a range from about 1:1 to 1:5.

22. The method of claim 17, wherein the thin film membrane is further physically separated from the given surface of the base membrane

23-27. (canceled)
